(19) United States
(12) Patent Application Publication
(10) Pub. No.: US 2014/0008326 A1
(43) Pub. Date: Jan. 9, 2014

(54) PLASMA GENERATION DEVICE, PLASMA PROCESSING APPARATUS AND PLASMA PROCESSING METHOD

(71) Applicants: NATIONAL UNIVERSITY CORPORATION NAGOYA UNIVERSITY, Nagoya-shi (JP); TOKYO ELECTRON LIMITED, Minato-ku (JP)

(72) Inventors: Hirotaka TOYODA, Nagoya-shi (JP); Masaru Hori, Nagoya-shi (JP); Makoto Sekine, Nagoya-shi (JP); Keigo Takeda, Nagoya-shi (JP); Hidenori Miyoshi, Nirasaki-shi (JP); Hitoshi Itoh, Nirasaki-shi (JP); Yusuke Kubota, Nirasaki-shi (JP)

(73) Assignees: NATIONAL UNIVERSITY CORPORATION NAGOYA UNIVERSITY, Nagoya-shi (JP); TOKYO ELECTRON LIMITED, Minato-ku (JP)

(21) Appl. No.: 14/023,006

(22) Filed: Sep. 10, 2013

Related U.S. Application Data
(63) Continuation of application No. PCT/JP2012/055331, filed on Mar. 2, 2012.

(30) Foreign Application Priority Data
Mar. 10, 2011 (JP) 2011-052941
Feb. 13, 2012 (JP) 2012-028187

(51) Int. Cl. H05H 1/46

(52) U.S. Cl. CPC H05H 1/46
USPC 216/69; 156/345.41

(57) ABSTRACT

A plasma generation device has a microwave generation device which generates microwave, a waveguide tube having hollow interior and connected to the microwave device such that the tube has longitudinal direction in transmission direction of microwave and rectangular cross section in direction orthogonal to the transmission direction, a phase-shifting device which cyclically shifts phase of standing wave generated in the tube by microwave, and a gas supply device which supplies processing gas into the tube. The tube has antenna portion having one or more slot holes which release plasma generated by microwave to the outside, the slot hole is formed on wall forming short or long side of the antenna portion, and the tube plasmatizes the gas in atmospheric pressure state supplied into the tube by the microwave in the slot hole and releases the plasma to the outside from the slot hole.

### CROSS-REFERENCE TO RELATED APPLICATIONS

The present application is a continuation of PCT/JP2012/055331, filed Mar. 2, 2012, which is based upon and claims the benefit of priority to Japanese Application Nos. 2011-052941, filed Mar. 10, 2011, and 2012-028187, filed Feb. 13, 2012. The entire contents of these applications are incorporated herein by reference.

### BACKGROUND OF THE INVENTION

1. Field of the Invention

The present invention relates to a plasma generation device that generates plasma utilizing a microwave as well as a plasma processing apparatus utilizing the plasma generation device and a plasma processing method.

2. Description of Background Art

As a microwave plasma processing apparatus that introduces a microwave into a processing container to generate plasma of a processing gas, there are a reduced pressure plasma system of reducing pressure in a processing container to generate plasma, and an atmospheric pressure plasma system of generating plasma at atmospheric pressure.

For example, in a reduced pressure plasma system of JP-A No. 2009-224269, there is provided a plasma processing device in which the arrangement and number of multiple slots formed in a longitudinal direction of a waveguide tube are defined by the relationship between a free space wavelength λ and an intratubular wavelength λg and, at the same time, an impedance in the waveguide tube seen from a microwave electric source side is set to be approximately equal to an impedance in the waveguide tube when an electric source side is seen in a reverse direction. In JP-A No. 2009-224269 adopting a reduced pressure plasma system, in order to retain reduced pressure in a processing container, a dielectric plate intervenes between the waveguide tube and the processing container.

As the reduced pressure plasma system, in JP-A No. 2004-200390, there is proposed a plasma processing device in which a waveguide tube that transmits a microwave is inserted into a vacuum container. In JP-A No. 2004-200390, it is stated that, by providing a waveguide tube in the vacuum container, a dielectric member for retaining vacuum can be downsized and thinned, and a workpiece having a large area can be uniformly treated. The device of JP-A No. 2004-200390 has a double structure in which the waveguide tube is arranged in the vacuum container that requires air tightness.

And, in JP-A No. 2004-200390, a dielectric plate is not provided, but a gas introduction site is provided on a side wall of the processing container remote from the waveguide tube.

As yet another example of the reduced pressure plasma system, a plasma generation device that generates large-scale microwave line plasma is described in “Large-Scaled Line Plasma Production by Microwave in Narrowed Rectangular Waveguide,” 27^{th} Plasma Processing Research Society (SPP-27) Proceedings Article P1-04 (Yasuhito Kimura et al.). In this plasma generation device, to reflect a microwave, a plunger whose position is adjustable is disposed on an end of a rectangular waveguide tube having a bottom on which one long slot is formed. This plasma generation device generates Ar plasma under a reduced pressure condition of around 667 Pa (5 Torr) in a stainless steel chamber which is vacuum-sealed with a glass plate.

On the other hand, as the atmospheric pressure plasma system, JP-A No. 2001-93871 proposes a plasma processing device having the following in the interior of a plasma generation portion: a slot antenna; a uniformity line connected to a slot forming surface of this slot antenna at a right angle to make a microwave uniform; and a slit provided on a tip side of this uniformity line to radiate a microwave. The plasma processing device of JP-A No. 2001-93871 is structured to treat a workpiece by plasma under atmospheric pressure by continuously supplying a process gas into a gap between the workpiece, which is formed on an outer side of the slit to generate plasma. This atmospheric pressure plasma processing device requires a slit of a waveguide tube and a slit of a uniformity line, and has a structure in which two each of waveguides and slots are provided.

Prior to this application, the present inventors have provided a plasma generation device in which a microwave is supplied into a long waveguide tube, multiple slot holes are formed on a wall of the waveguide tube corresponding to a position of an antinode of a standing wave of a microwave formed in a longitudinal direction in the waveguide tube, and high density atmospheric pressure plasma is generated in the interior of the slot holes (Japanese Patent Application No. 2010-207774).

The entire contents of these publications are incorporated herein by reference.

### SUMMARY OF THE INVENTION

According to one aspect of the present invention, a plasma generation device has a microwave generation device which generates a microwave, a waveguide tube having a hollow interior space and connected to the microwave generation device such that the waveguide tube has a longitudinal direction in a transmission direction of the microwave and a rectangular cross section in a direction orthogonal to the transmission direction, a phase-shifting device which cyclically shifts a phase of a standing wave generated in the interior space of the waveguide tube by the microwave, and a gas supply device which is connected to the waveguide tube and supplies a processing gas into the interior space of the waveguide tube. The waveguide tube has an antenna portion having one or more slot holes which release plasma generated by the microwave to the outside of the waveguide tube, the slot hole is formed on a wall forming a short side or a long side of the antenna portion, and the waveguide tube plasmatizes the processing gas in the atmospheric pressure state supplied into the interior space of the waveguide tube by the microwave in the slot hole and releases the plasma to the outside from the slot hole.

According to another aspect of the present invention, a plasma processing apparatus has a support device which supports a workpiece, and a plasma generation device which generates plasma and releases the plasma toward the workpiece supported by the support device. The plasma generation device has a microwave generation device which generates a microwave, a waveguide tube having a hollow interior space and connected to the microwave generation device such that waveguide tube has a longitudinal direction in a transmission direction of the microwave and has a rectangular cross section in a direction orthogonal to the transmission direction, a phase-shifting device which cyclically shifts a phase of a standing wave generated in the interior space of the waveguide tube by the microwave, and a gas supply device which is connected to the waveguide tube and supplies a processing gas into the interior space of the waveguide tube, the waveguide tube has an antenna portion having one or more slot holes which release plasma generated by the microwave to the outside of the waveguide tube, the slot hole is formed on a wall forming a short side or a long side of the antenna portion, and the waveguide tube plasmatizes the processing gas in the atmospheric pressure state supplied into the interior space of the waveguide tube by the microwave in the slot hole and releases the plasma to the outside from the slot hole such that the plasma applies processing on the workpiece.

According to yet another aspect of the present invention, a plasma processing method includes generating plasma using a plasma generation device, and releasing the plasma generated by the plasma generation device from the plasma generation device such that the plasma applies processing on a workpiece. The plasma generation device has a microwave generation device which generates a microwave, a waveguide tube having a hollow interior space and connected to the microwave generation device such that waveguide tube has a longitudinal direction in a transmission direction of the microwave and has a rectangular cross section in a direction orthogonal to the transmission direction, a phase-shifting device which cyclically shifts a phase of a standing wave generated in the interior space of the waveguide tube by the microwave, and a gas supply device which is connected to the waveguide tube and supplies a processing gas into the interior space of the waveguide tube, the waveguide tube has an antenna portion having one or more slot holes which release plasma generated by the microwave to the outside of the waveguide tube, the slot hole is formed on a wall forming a short side or a long side of the antenna portion, and the waveguide tube plasmatizes the processing gas in the atmospheric pressure state supplied into the interior space of the waveguide tube by the microwave in the slot hole and releases the plasma to the outside from the slot hole such that the plasma applies processing on the workpiece.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram schematically showing a plasma processing apparatus of a first embodiment of the present invention;

FIG. 2 is a view showing an example of the structure of a microwave generation device;

FIG. 3 is an enlarged cross-sectional view of a main portion in FIG. 1;

FIG. 4 is a view illustrating the positional relationship between a slot hole and a block in a rectangular waveguide tube;

FIG. 5 is a view illustrating a mechanism in which a phase of a standing wave in a rectangular waveguide tube is shifted;

FIG. 6 is a view showing an example of the structure of a control portion;

FIG. 7 is a perspective view illustrating a slot hole of an antenna portion of a rectangular waveguide tube;

FIG. 8 is a plan view of a surface on which the slot hole in FIG. 7 is formed;

FIG. 9 is an enlarged plan view of the slot hole in FIG. 8;

FIG. 10 is a plan view illustrating another example of the formation of a slot hole of an antenna portion of a rectangular waveguide tube;

FIG. 11 is a plan view illustrating yet another example of the formation of a slot hole of an antenna portion of a rectangular waveguide tube;

FIG. 12 is a view showing an example of a cross-sectional shape of a slot hole;

FIG. 13 is a view illustrating another example of a cross-sectional shape of a slot hole;

FIG. 14 is a diagram schematically showing a plasma processing apparatus of a second embodiment of the present invention;

FIG. 15 is an enlarged cross-sectional view of a main portion in FIG. 14;

FIG. 16 is a view illustrating the positional relationship between a slot hole and a rotor in a rectangular waveguide tube;

FIG. 17A is a view showing an example of the structure of a rotor in a plasma processing apparatus of a second embodiment of the present invention;

FIG. 17B is a view showing another example of the structure of a rotor in a plasma processing apparatus of a second embodiment of the present invention;

FIG. 17C is a view showing yet another example of the structure of a rotor in a plasma processing apparatus of a second embodiment of the present invention;

FIG. 17D is a view showing yet another example of the structure of a rotor in a plasma processing apparatus of a second embodiment of the present invention;

FIG. 18A is a plan view showing yet another example of the structure of a rotor in a plasma processing apparatus device of a second embodiment of the present invention;

FIG. 18B is a cross-sectional view of a B-B line arrow of FIG. 18A;

FIG. 19 is cross-sectional view illustrating a main portion of a modified example of a second embodiment;

FIG. 20 is a diagram schematically showing the structure of a plasma processing apparatus device of a third embodiment of the present invention;

FIG. 21 is an enlarged cross-sectional view of a main portion in FIG. 20;

FIG. 22A is a view showing an example of the structure of a rotor in a plasma processing apparatus of a third embodiment of the present invention;

FIG. 22B is a view showing another example of the structure of a rotor in a plasma processing apparatus of a third embodiment of the present invention;

FIG. 23 is a diagram schematically showing the structure of a plasma processing apparatus of a fourth embodiment of the present invention;

FIG. 24 is an enlarged cross-sectional view of a main portion in FIG. 23;

FIG. 25 is a diagram schematically showing the structure of a plasma processing apparatus of a fifth embodiment of the present invention;

FIG. 26 is a view schematically illustrating the structure of a phase shifter;

FIG. 27A is a cross-sectional view of a rectangular waveguide tube according to a sixth embodiment of the present invention;

FIG. 27B is another cross-sectional view of a rectangular waveguide tube according to the sixth embodiment of the present invention;

FIG. 27C is yet another cross-sectional view of a rectangular waveguide tube according to the sixth embodiment of the present invention;

FIG. 28 is a diagram illustrating an example of the structure of a plasma processing apparatus in which multiple antenna portions of a seventh embodiment of the present invention are arranged in parallel;

FIG. 29 is a diagram illustrating an example of the structure of a plasma processing apparatus that conveys a workpiece by a roll-to-roll system;

FIG. 30 is a diagram illustrating another example of the structure of a plasma processing apparatus that conveys a workpiece by a roll-to-roll system;

FIG. 31A is a view showing an arrangement of a block in simulation;

FIG. 31B is view showing another arrangement of a block in simulation;

FIG. 31C is a view illustrating dimensions of a block in simulation;

FIG. 32 is a graph showing the relationship between a phase shift and the insertion depth by simulation; and

FIG. 33 is a graph showing the relationship between a phase shift and the width of a block by another simulation.

### DETAILED DESCRIPTION OF THE EMBODIMENTS

The embodiments will now be described with reference to the accompanying drawings, wherein like reference numerals designate corresponding or identical elements throughout the various drawings.

### First Embodiment

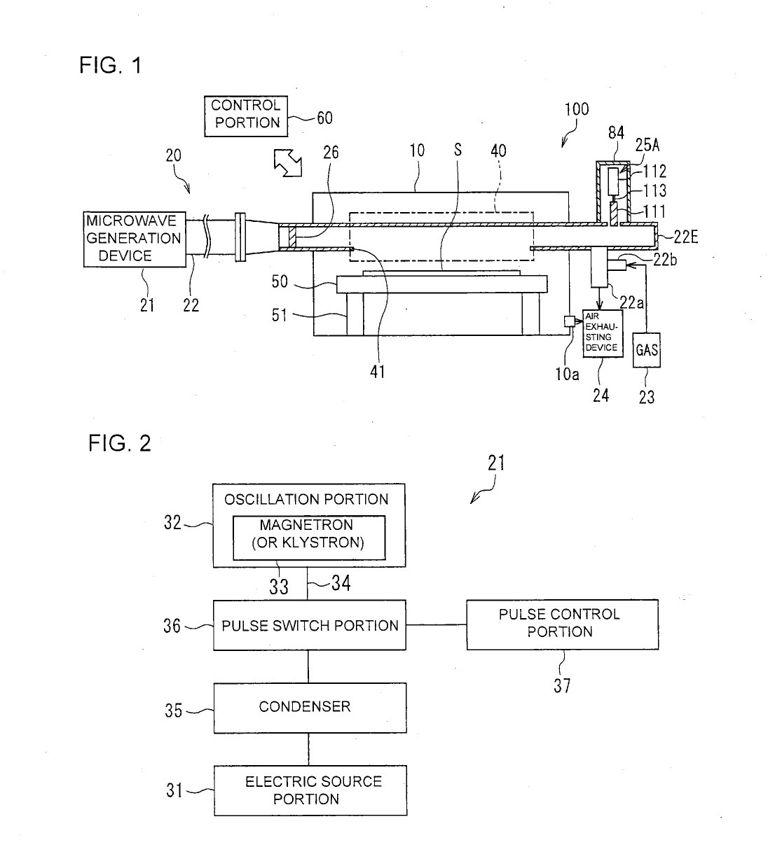

FIG. 1 is a diagram schematically showing the structure of a plasma processing apparatus 100 of a first embodiment of the present invention. The plasma processing apparatus 100 of FIG. 1 includes a processing container 10; a plasma generation device 20 that generates plasma and releases plasma toward a workpiece (S) in the processing container 10; a stage 50 that supports the workpiece (S); and a control portion 60 that controls the plasma processing apparatus 100 and is an atmospheric pressure plasma processing apparatus that conducts processing on the workpiece (S) at a normal temperature.

### Processing Container

A processing container 10 is used for compartmenting a plasma processing space, and can be formed of, for example, a metal such as aluminum, stainless steel or the like. It is preferable that the interior of the processing container 10 has been subjected to, for example, surface processing that enhances resistance to plasma erosion, such as alumite processing. In the processing container 10, an opening is provided for loading/unloading the workpiece (S) (not shown). In addition, since the plasma processing apparatus 100 of the present embodiment is of an atmospheric pressure plasma system, it is not always necessary to provide the processing container 10, but is optional.

### Plasma Generation Device

A plasma generation device 20 includes a microwave generation device 21 that generates a microwave; a rectangular waveguide tube 22 that is connected to the microwave generation device 21 and includes an antenna portion 40 as a part thereof; a gas supply device 23 that is connected to the rectangular waveguide tube 22 and supplies a processing gas into the interior thereof; an air exhausting device 24 for exhausting a gas in the antenna portion 40 and, optionally, the air in a processing container 10; a phase shifting device (25A) as a means of phase shifting, which cyclically shifts a phase of a standing wave in the rectangular waveguide tube 22 (particularly, in the antenna portion 40); and a partition 26 made of a dielectric such as quartz for blocking passage of a processing gas in the interior of the rectangular waveguide tube 22. Also, a slot hole 41 is formed on one wall surface of the rectangular waveguide tube 22. The region in which the slot hole 41 is formed works as an antenna portion 40 that releases plasma generated in the slot hole 41 toward a workpiece (S) on the outside.

### Microwave Generation Device

A microwave generation device 21 generates a microwave of a frequency of, for example, 2.45 GHz to 100 GHz, preferably 2.45 GHz to 10 GHz. The microwave generation device 21 of the present embodiment has a pulse oscillation function and can generate a pulse-type microwave. An example of the structure of the microwave generation device 21 is shown in FIG. 2. In the microwave generation device 21, a capacitor 35 and a pulse switch portion 36 are provided on a high voltage line 34 connecting from an electric source portion 31 to a magnetron (klystron) 33 of an oscillation portion 32. A pulse control portion 37 is connected to the pulse switch portion 36, and inputting of a control signal that controls a frequency and a duty ratio is conducted.

This pulse control portion 37 receives commands from a controller 61 (described later) of a control portion 60, and outputs a control signal toward the pulse switch portion 36. And, by inputting a control signal into the pulse switch portion 36 while high voltage is supplied from electric source portion 31, a rectangular wave of predetermined voltage is supplied to the magnetron (or klystron) 33 of the oscillation portion 32, and a microwave pulse is output. A pulse of this microwave can be controlled at a pulse-on-time of 10 to 50 μsec, a pulse-off-time of 200 to 500 μsec, and a duty ratio of 5 to 70%, preferably 10 to 50%. In addition, in the present embodiment, the pulse oscillation function is provided to prevent heat accumulation at the antenna portion 40 that may cause a transition from low-temperature non-equilibrium discharge to arc discharge when continuously discharged. Therefore, when a cooling mechanism of the antenna portion 40 is separately provided, it is an option to provide such a pulse oscillation function.

Although omitted from showing in the drawings, a microwave generated in the microwave generation device 21 is transmitted to the antenna portion 40 set to be a part of the rectangular waveguide tube 22 via an isolator that controls the direction of a microwave and a matching device that performs impedance matching of a waveguide tube.

### Waveguide Tube

A rectangular waveguide tube 22 is long in a transmission direction of a microwave and, at the same time, is hollow in such a way that a cross section in a direction orthogonal to a transmission direction of a microwave is rectangular. The rectangular waveguide tube 22 is formed of, for example, a metal such as copper, aluminum, iron, stainless steel or the like, or an alloy thereof.

The rectangular waveguide tube 22 includes an antenna portion 40 as a part thereof. In the present embodiment, the antenna portion 40 has one slot hole 41 on a wall set to be a short side or on a wall set to be a long side in a cross section thereof. Namely, a region that is part of the rectangular waveguide tube 22 and in which the slot hole 41 is formed corresponds to the antenna portion 40. In FIG. 1, the antenna portion 40 is shown by a chain line surrounding the portion. The length of the antenna portion 40 can be determined by the size of a workpiece (S) and, for example, is preferably 0.3 to 1.5 m. The slot hole 41 is an opening penetrating through a wall set to be a short side or a wall set to be a long side in a cross section of the antenna portion 40. The slot hole 41 is provided to face the workpiece (S) for radiating plasma toward the workpiece (S). In addition, the arrangement and shape of the slot hole 41 are described later.

### Gas Supply Device

A gas supply device (GAS) 23 is connected to a gas introduction portion (22b) provided in a branch tube 22a that branches from the rectangular waveguide tube 22 between the antenna portion 40 and an end portion (22E) of the rectangular waveguide tube 22. The gas supply device 23 includes a gas supply source, a valve, a flow rate controlling device and the like, which are not shown. The gas supply source is provided for each type of processing gas. Examples of the processing gas include hydrogen, nitrogen, oxygen, a water steam, a flon (CF₄) gas and the like. In the case of the flon (CF₄) gas, it is necessary to provide an air exhausting device 24 as well. Also, for example, a supply source of an inactive gas such as argon, helium, a nitrogen gas or the like can be also provided. A processing gas supplied into the rectangular waveguide tube 22 from the gas supply device 23 is plasmatized by generation of discharge by a microwave in the slot hole 41.

### Air Exhausting Device

An air exhausting device 24 includes a valve, a turbo-molecular pump, a dry pump and the like, which are not shown. The air exhausting device 24 is connected to a branch tube (22a) of the rectangular waveguide tube 22 and an exhaust port (10a) of a processing container 10, in order to exhaust the air in the rectangular waveguide tube 22 and the processing container 10. For example, when the process is ended, a processing gas remaining in the rectangular waveguide tube 22 is rapidly removed from the rectangular waveguide tube 22 by actuating the air exhausting device 24. Also, when discharge is initiated, the air exhausting device 24 is used to have a processing gas replaced effectively with a gas in the atmosphere of the rectangular waveguide tube 22 and processing container 10. In addition, in the plasma processing apparatus 100 of the present embodiment, which is an atmospheric pressure plasma processing apparatus, it is an option for the air exhausting device 24 to be provided. However, when a processing gas, particularly, a CF₄ gas, which is stable at a normal temperature, produces a fluorine radical (F) or a fluorocarbon radical (CxFy) which is highly reactive when plasmatized, it is preferable for the air exhausting device 24 to be provided.

### Phase Shifting Device

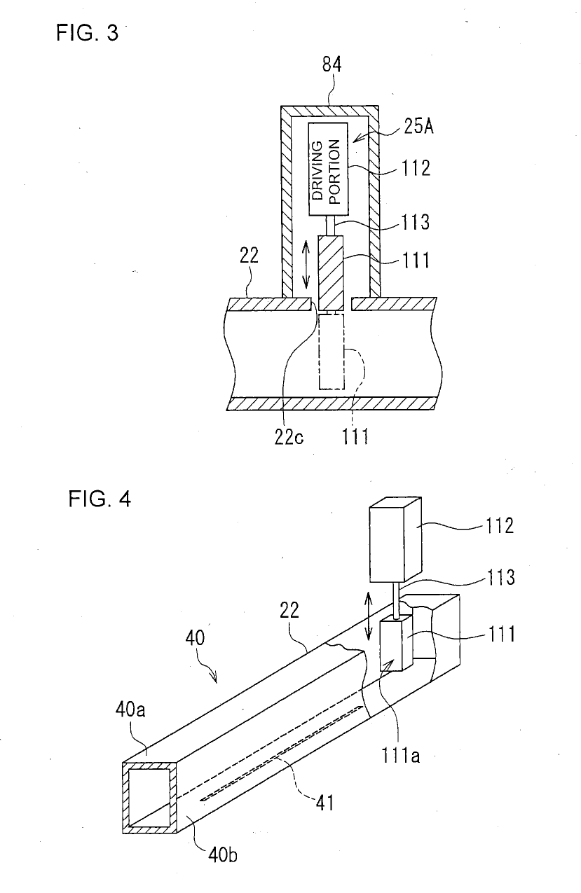

A phase shifting device (25A) of the present embodiment has a wall member that makes a linear motion, advancing into and retracting from the rectangular waveguide tube 22, in a direction crossing (preferably, a direction orthogonal to) a longitudinal direction of the rectangular waveguide tube 22. The phase shifting device (25A) causes the wall member to shuttle cyclically in a linear motion. Specifically, as shown in FIGS. 3 and 4, the phase shifting device (25A) includes a block 111 as a “wall member that makes a linear motion, advancing into and retracting from the rectangular waveguide tube 22,” a driving portion 112 that causes the block 111 to shuttle back and forth in a linear motion, and a shaft 113 which supports the block 111 while connecting the block 111 and the driving portion 112 to transfer the power from the driving portion 112 to the block 111. The driving portion 112 causes the block 111 to advance into and retract from the rectangular waveguide tube 22 at a predetermined stroke length through an insertion opening (22c) provided in the rectangular waveguide tube 22. The driving portion 112 may be formed with, for example, an air cylinder, an oil hydraulic cylinder or the like, or may be formed by combining a driving source such as a motor or the like with a crank mechanism, a Scotch yoke mechanism, a rack and pinion mechanism or the like. In this way, the phase shifting device (25A) actuates the driving portion 112 to shuttle the block 111 in a vertical linear motion so that block 111 is inserted into or extracted from the rectangular waveguide tube 22. Accordingly, a phase of a standing wave is shifted cyclically in a longitudinal direction of the rectangular waveguide tube 22.

### Block

As a material of the block 111, for example, a dielectric such as quartz, alumina and the like, or a metal such as aluminum, stainless steel and the like can be used. When the dielectric is used, it is preferable to use a dielectric material having a large specific dielectric constant ∈ᵣ and a small dielectric tangent (tan δ). In addition, a specific dielectric constant ∈ᵣ may be non-uniform in the block 111, and the block 111 can be formed of two or more dielectrics having different specific dielectric constants ∈ᵣ. The shape of the block 111 can be like that of a plate, or a prism or square tube, as shown in FIG. 3 and FIG. 4. In the following, phenomena that occur when the block 111 is inserted into the rectangular waveguide tube 22 are described.

### Block 111 is a Dielectric Material:

When a block 111 is a dielectric, transmission, absorption and reflection of a microwave that propagates through the rectangular waveguide tube 22 are generated in the block 111. To what degree the transmission, absorption and reflection of a microwave are generated differs depending on the specific dielectric constant ∈ᵣ and loss coefficient (∈ᵣ×tan δ) of the material making up the block 111.

When the block 111 is made of a material having a small loss coefficient (e.g. quartz or high purity alumina), most of a microwave is transmitted through the block 111, and absorption and reflection are reduced relatively. In this case, since a wall surface (111a) of the block 111 is smaller than a cross section of the rectangular waveguide tube 22, a part of a microwave irradiated to the block 111 is propagated by transmitting through the block 111, and the remaining microwave is propagated by diffracting around the block 111. Also, a wavelength λd of a microwave transmitted in a dielectric becomes smaller than an intratubular wavelength λg [λd=λg/sqrt(∈ᵣ); herein, sqrt means a square root].

Due to such a difference in wavelengths, an associated wave after it has passed through the block 111 is refracted to a side of the block 111 that is a dielectric. By this refraction, a phase of a standing wave is shifted, and positions of an antinode and a node of a standing wave generated in the rectangular waveguide tube 22 are moved. And, in order to make a wavelength λd smaller than an intratubular wavelength λg, it is desirable to use a material having a large specific dielectric constant ∈ᵣ in the block 111.

When the block 111 is made of a material having a great loss coefficient, the amount of a microwave that is absorbed in the block 111 is increased, a dielectric becomes easily heated, and the power loss of a microwave that was output and supplied from the microwave generation device 21 increases. As a result, since the amount of a microwave that can be used for plasma discharge is reduced, this is not desirable. Therefore, as a material of the block 111, it is desirable to use a dielectric material having a large specific dielectric constant ∈ᵣ and a small loss coefficient (∈ᵣ×tan δ). Since a loss coefficient is a product of a specific dielectric constant ∈ᵣ and a dielectric tangent tan δ, for both a large specific dielectric constant ∈ᵣ and a small loss coefficient to be realized, the dielectric tangent tan δ needs to be small. That is, as a material of the block 111, it is desirable to use a dielectric material having a large specific dielectric constant ∈ᵣ and a small dielectric tangent tan δ.

### Block 111 is a Metal Material:

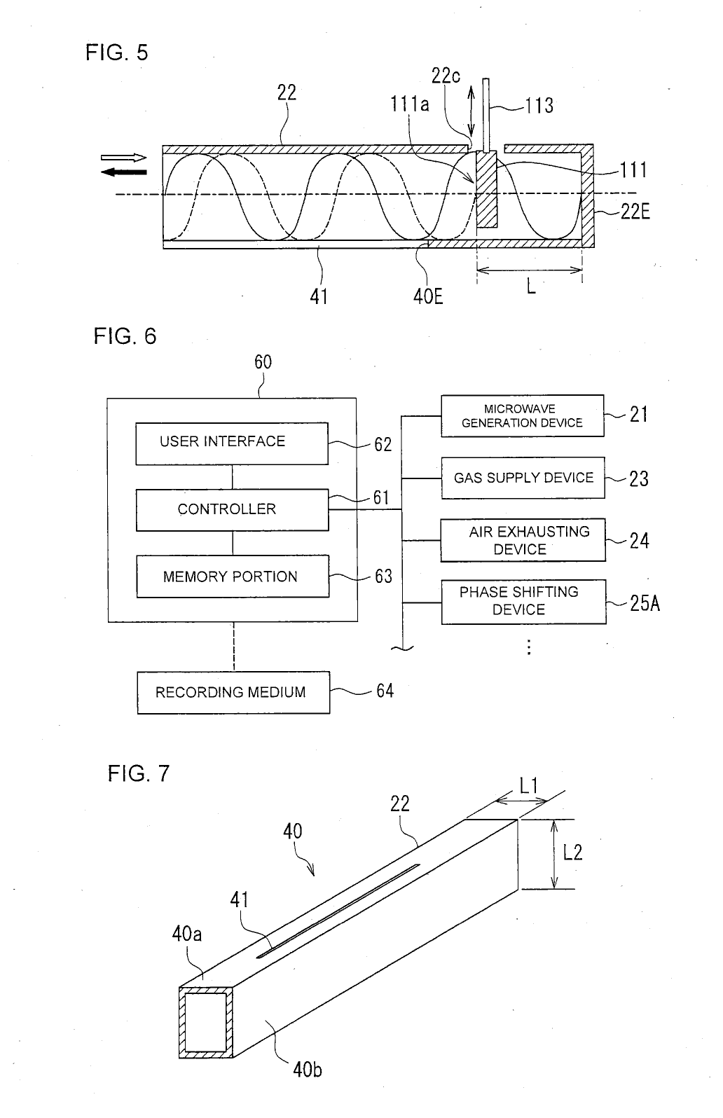

When a block 111 is a metal, substantially the entire microwave that propagates through the rectangular waveguide tube 22 is reflected by a wall surface (111a) of the block 111. For this reason, as shown in FIG. 5, an end portion of the rectangular waveguide tube 22 is positioned substantially at an insertion position of a wall surface (111a) of the block 111, making the waveguide length of the rectangular waveguide tube 22 substantially shorter. Accordingly, positions of an antinode and a node of a standing wave generated in the rectangular waveguide tube 22 are moved. In FIG. 5, a waveform of a standing wave in the original rectangular waveguide tube 22 is shown with a solid line, and a waveform of a standing wave after positions of an antinode and a node are moved by insertion of the block 111 of the phase shifting device (25A) is shown with a broken line. Also, a progression direction of a microwave propagating through the rectangular waveguide tube 22 from the microwave generation device 21 is shown with a void arrow, and a progression direction of a reflected wave thereof is shown with a black arrow.

By contrast, when the block 111 has been extracted from a rectangular waveguide tube 22 (when the block 111 has been pulled up to an upper position as shown in FIG. 3), since transmission, absorption and reflection by the block 111 are not generated, the standing wave is returned to its original phase, and positions of an antinode and a node are recovered as before.

As described above, by shuttling the block 111 cyclically into and out of the rectangular waveguide tube 22, positions of an antinode and a node of a standing wave are moved on a predetermined cycle. Accordingly, line plasma is generated to be uniform by time average in a slot hole 41 in a longitudinal direction of an antenna portion 40. Therefore, the process on a workpiece is conducted homogeneously in a longitudinal direction of the antenna portion 40.

The block 111 has a wall surface (111a) that faces a microwave propagating through the rectangular waveguide tube 22. When an area of this wall surface (111a) is too small, transmission or reflection is hard to achieve, and when the area is too great, the material cost of the block 111 rises.

In order to prevent a microwave from leaking from an insertion opening (22c) to the outside, it is preferable for the phase shifting device (25A) to be covered with a cover member 84, as shown in FIG. 1 and FIG. 3. As a material of the cover member 84, for example, a metal such as aluminum, stainless steel or the like can be used.

A position at which the phase shifting device (25A) is disposed is not particularly limited but is preferred to be a position in the vicinity of an end portion (22E) of the rectangular waveguide tube 22. Particularly, by setting a position of the wall surface (111a) of the block 111 of the phase shifting device (25A) at the position of an antinode of a standing wave that was originally generated in the rectangular waveguide tube 22, positions of an antinode and a node of a standing wave are easier to move. Herein, a node of a standing wave originally generated in the rectangular waveguide tube 22 corresponds to an inner wall surface of the end portion (22E) of the rectangular waveguide tube 22 that is a fixed end. Therefore, as shown in FIG. 5, as for a position to set the phase shifting device (25A), it is preferred to be between the end portion (40E) of the antenna portion 40 and the end portion (22E) of the rectangular waveguide tube 22, having a distance L from the inner wall surface of the end portion (22E) of the rectangular waveguide tube 22 at n×λg/4 (herein, (n) means a positive odd integer, preferably 1, 3 or 5) relative to an intratubular wavelength λg of a standing wave.

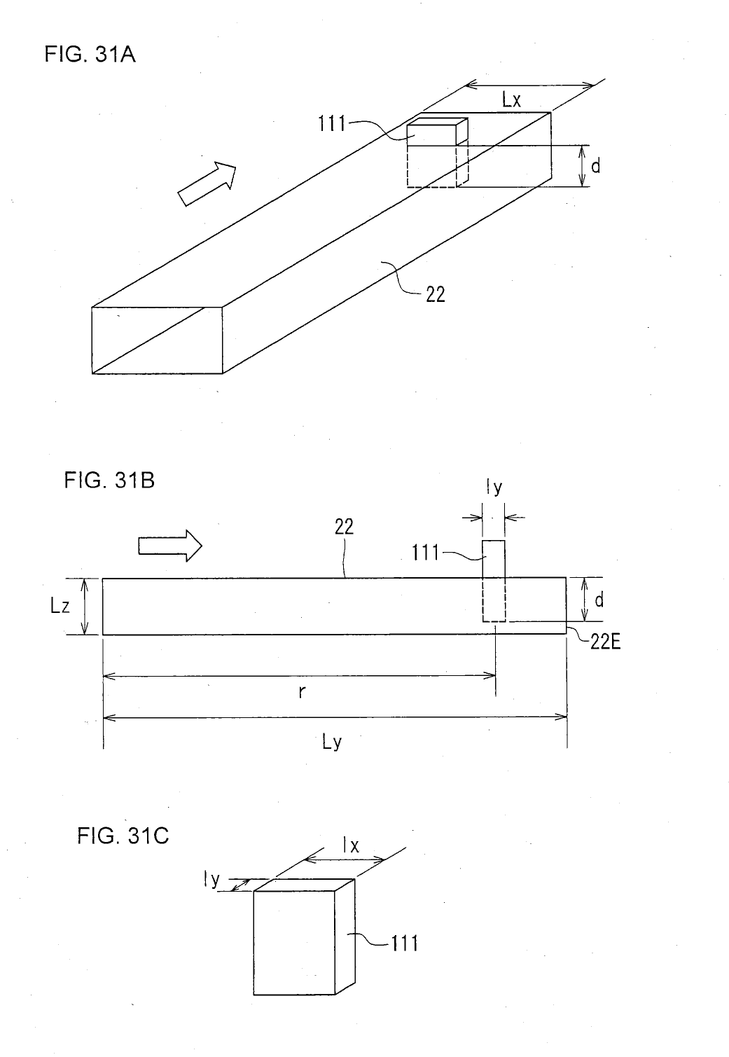

When the amount of insertion of the block 111 inserted into the rectangular waveguide tube 22 (see symbol (d) of FIGS. 31A, 31B) is too small, transmission or reflection is hard to achieve, whereas when the amount is too great, it is thought that the block 111 may be damaged by contact and collision with an inner surface of the rectangular waveguide tube 22 if the actual insertion amount is shifted from a desired insertion amount.

A period of a shuttling motion, with a cycle being an action of the block 111 advancing into and retracting from the rectangular waveguide tube 22, is preferably 1/1000 to ½ of a plasma processing process time, from the viewpoint of the uniformity of a plasma processing process, throughput and simplification of a driving mechanism.

The phase shifting device (25A) is not limited to an aspect in which the block 111 is inserted from above the rectangular waveguide tube 22, but may be structured so that the block 111 is moved into and out of the rectangular waveguide tube 22 from the left or right of, or from below the rectangular waveguide tube 22. Namely, the phase shifting device (25A) can be arranged on any of the upper, lower, left and right outer wall surfaces of the rectangular waveguide tube 22.

### Partition

In the present embodiment, the plasma generation device 20 includes a partition 26 that blocks passage of a processing gas in the rectangular waveguide tube 22 between the microwave generation device 21 and the antenna portion 40. The partition 26 is made of a dielectric, for example, quartz or polytetrafluoroethylene such as Teflon (registered trademark), and prevents a processing gas in the rectangular waveguide tube 22 from flowing toward the microwave generation device 21, while passing a microwave.

### Stage

A stage 50 supports a workpiece (S) positioned horizontal in a processing container 10. The stage 50 is provided to be supported by a supporting portion 51 disposed on a bottom of the processing container 10. Materials for the stage 50 and the supporting portion 51 are, for example, ceramics such as quartz, AlN, Al₂O₃ and BN, and metals such as Al and stainless steel. If necessary, a heater (not shown) may be embedded so that the workpiece (S) can be heated to around 250° C. In addition, in the plasma processing apparatus 100 of the present embodiment, the stage 50 is not limited specifically, and is selected based on the type of workpiece (S).

### Workpiece

The plasma processing apparatus 100 can be applied on a workpiece (S) such as, for example, an FPD (flat panel display) substrate, a type of which is a glass substrate for LCD (liquid crystal indication display); a film member such as a polycrystalline silicon film; and a polyimide film adhered to the FPD substrate. Also, the plasma processing apparatus 100 can be used on a workpiece (S) such as, for example, a film member such as a polyethylene naphthalate (PEN) film, or a polyethylene terephthalate (PET) film, to perform surface cleaning processing or surface processing thereof so that an active element and a passive element such as an organic semiconductor are formed. Further, the plasma processing apparatus 100 can be used to perform, for example, modification processing of a thin film provided on an FPD substrate as the workpiece (S), or surface processing, cleaning processing and modification processing on the film member used as the workpiece (S) to improve adhesiveness to an FPD substrate. In the plasma processing apparatus 100 having the phase shifting device (25A), since high density line plasma is uniformly formed over the entire region of a long antenna portion 40, processing on the workpiece (S) having a relatively large area is performed effectively and homogeneously.

### Control Portion

Each portion of the plasma processing apparatus 100 is structured to be controlled by being connected to a control portion 60. As shown in FIG. 6, the control portion 60 having computer functions includes a controller 61 equipped with a CPU, a user interface 62 connected to the controller, and a memory portion 63. The memory portion 63 stores a control program (software) to execute various processing in the plasma processing apparatus 100 under the control of the controller 61, and a specification in which processing condition data or the like are recorded. The controller 61 makes an access to a control program or a specification stored in the memory portion 63 according to a command from the user interface 62 or the like, and executes the command to perform desired processing by the plasma processing apparatus 100 using portions of the plasma processing apparatus 100 (e.g. microwave generation device 21, gas supply device 23, air exhausting device 24, phase shifting device (25A)) under control of the control portion 60. In addition, the control program or specifications as processing condition data are also used by installing into the memory portion 63 the program or specifications stored in a computer readable recording medium 64. The computer readable recording medium 64 is not limited to any specific type, and a CD-ROM, hard disk, flexible disk, flash memory or DVD, for example, can be employed. Alternatively, the specifications are also available online by transmitting them from another device, for example, via a dedicated line.

### Structure of Slot Hole

Next, the arrangement and shape of a slot hole 41 in an antenna portion 40 are described using specific examples, referring to FIG. 7 to FIG. 13. The slot hole 41 is an opening penetrating through a wall (40a) (or it may be a wall 40b) of the rectangular waveguide tube 22. In the plasma processing apparatus 100, the wall (40a) (or wall 40b) on which the slot hole 41 is disposed is arranged to face a workpiece (S). It is preferable for the arrangement and shape of the slot hole 41 to be designed so that plasma is generated in most of the opening (preferably, an entire area of the opening) of the slot hole 41. In order to generate plasma in most of the opening of the slot hole 41, a combination of the arrangement and shape of the slot hole 41 is important. From such a viewpoint, a preferable aspect of the arrangement and shape of the slot hole 41 is described below.

### Single Slot Hole

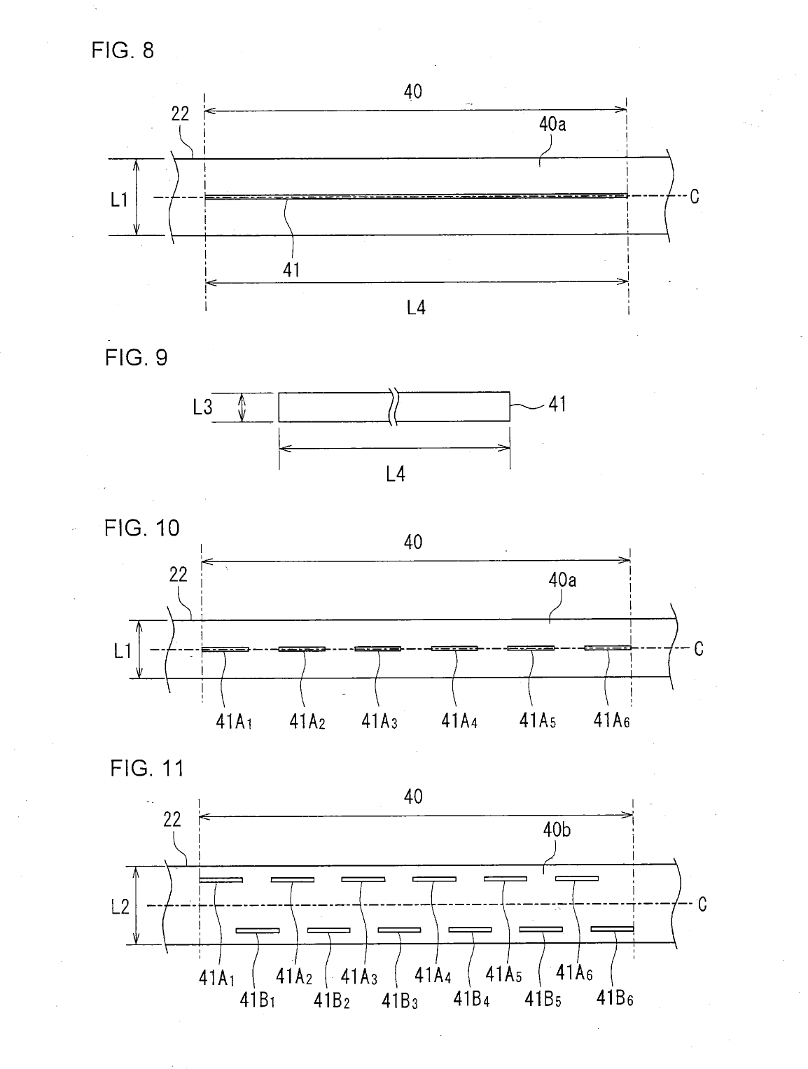

FIG. 7 and FIG. 8 show an example in which one elongated rectangular slot hole 41 is formed on one wall (40a) set to be a short side of a rectangular waveguide tube 22 constituting an antenna portion 40. FIG. 7 shows, upwardly, a plane (wall 40a), on which the slot hole 41 is formed, of an antenna portion 40 of the rectangular waveguide tube 22. FIG. 8 is a plan view of the wall 40a in FIG. 7 and FIG. 9 is an enlarged view of the slot hole 41.

When the length of a short side of a cross section of the antenna portion 40 is set as (L1) and the length of a long side as (L2) (that is, L1<L2), the slot hole 41 may be formed on any portion of the wall (40a) forming a short side, and the wall (40b) forming a long side, in a cross section of the antenna portion 40, but it is preferable for the slot hole 41 to be disposed on the wall (40a) forming a short side and having the length of (L1), as shown in FIG. 7 and FIG. 8. A radio wave of a microwave reaches an inner wall surface of an end portion (22E) of the rectangular waveguide tube 22 while reflecting between one pair of walls (40a) as a short side of the rectangular waveguide tube 22, reflects there, progresses in a direction reverse to a progression direction in the rectangular waveguide tube 22, and forms a standing wave. A magnetic wave orthogonal to the radio wave progresses while reflecting between one pair of walls (40b) as a long side of the rectangular waveguide tube 22, reflects on an inner surface of an end portion (22E) of the rectangular waveguide tube 22, progresses in a direction reverse to a progression direction, and forms a standing wave of the magnetic field. As described, a microwave enters the antenna portion 40, which is a part of the rectangular waveguide tube 22, and forms standing waves of a radio wave and the magnetic field respectively. Among those, when the slot hole 41 is formed on a portion of an antinode of a standing wave of a radio wave, strong plasma is formed. Therefore, it is preferable for the slot hole 41 to be provided on the wall (40a), which forms a short side of the antenna portion 40 of the rectangular waveguide tube 22. As shown in FIG. 9, the slot hole 41 can be a long rectangle having the length (L4), which is a few times to tens of times the size of width (L3).

As shown in FIGS. 7 and 8, the slot hole 41 is formed on the wall (40a) that forms a short side of the rectangular waveguide tube 22, and a surface current flowing on the wall (40a) flows in a direction orthogonal to a central axis in a direction of the length of the waveguide tube. For this reason, if the slot hole 41 is parallel in a longitudinal direction of the antenna portion 40, even when the slot hole is provided at any position in a width direction of the wall (40a) that forms a short side, a surface current results, flowing orthogonal to a longitudinal direction of the slot hole 41, and strong plasma is obtained. To simplify the design, it is preferable for the slot hole 41 to be provided near the center of the wall (40a) that forms a short side [near a line connecting centers in a width direction of the wall (40a) in a longitudinal direction of the rectangular waveguide tube 22 (central line C)]. In addition, the slot hole 41 is not limited to being one, but multiple slot holes may also be provided at the antenna portion 40. Also, two or more long slot holes 41 may be provided in parallel.

### Multiple Slot Holes

In FIG. 10 and FIG. 11, another construction example of the slot hole 41 is shown. In FIG. 10, six rectangular slot holes 41 formed on the wall (40a) that forms a short side of the antenna portion 40 are indicated by symbols (41A₁) to (41A₆). In FIG. 10, the antenna portion 40 is between an edge of two slot holes (41A₁) positioned on an outermost side and an edge of a slot hole (41A₆). It is preferable for an arrangement interval of slot holes (41A₁) to (41A₆) arranged in one row to be determined depending on intratubular wavelength. For the purpose of radiating high density plasma, it is preferable for adjacent slot holes 41 to be close to each other, and for intervals between them to be small. The length (L4) and the width (L3) of respective slot holes (41A₁) to (41A₆) are optional, but it is preferable for the slot hole to have a narrow width and elongated shape. It is preferable for respective slot holes 41 to be provided so that a longitudinal direction thereof corresponds to a longitudinal direction of the antenna portion 40 (i.e. longitudinal direction of rectangular waveguide tube 22), and that they are parallel. When a longitudinal direction of the slot hole 41 is formed not parallel but at an angle relative to a longitudinal direction of the antenna portion 40, since a portion of an antinode of a radio wave crosses the slot hole 41 obliquely, a portion of the antinode of a radio wave cannot be effectively utilized, and it becomes difficult to produce plasma in an entire opening of the slot hole 41.

The slot holes 41 may be disposed in one row or in multiple rows. An example in which multiple slot holes 41 are disposed in two rows is shown in FIG. 11. In FIG. 11, multiple (6 in this example) rectangular slot holes 41 are each disposed straight on the wall 40b that forms a long side of the antenna portion 40, to make rows, and rectangular slot holes are disposed in a total of two rows. Namely, in FIG. 11, slot holes (41A₁) to (41A₆) are arranged straight as one set, forming rows, and slot holes (41B₁) to (41B₆) are arranged straight, as one set, forming rows. In FIG. 11, the antenna portion 40 is between edges of two slot holes (41A₁) positioned on an outermost side and an edge of a slot hole (41B₆).

To obtain strong plasma, it is preferred for the rectangular slot hole 41 to be provided at a portion of an antinode of a standing wave generated in the rectangular waveguide tube 22 when the slot hole 41 is formed on the wall (40b) as a long side of the rectangular waveguide tube 22. In such a case, the electromagnetic field reaches its maximum value at a portion of an antinode of a standing wave, a surface current flowing on the wall (40b) that forms a long side flows in a direction from a portion of an antinode of a standing wave toward the wall (40a) that forms a short side of the rectangular waveguide tube 22, and the surface current increases as it comes closer to the wall 40a. Therefore, when the rectangular slot hole 41 is formed to be shifted toward a portion near the wall 40a that forms a short side of the rectangular waveguide tube 22 (side near a corner) rather than near the center of a wall surface of the wall (40b) that forms a long side, strong plasma is formed in the slot hole 41. For example, in FIG. 11, slot holes 41 are arranged in two rows at a position deviating from a central line C in a width direction of the wall 40b. In this way, by providing a row of slot holes 41 away from a central line C, a surface current flowing on a wall surface of the wall 40b reaches its maximum value, energy loss is reduced, and high density plasma can be radiated.

When two or more rows of slot holes 41 are disposed next to each other as shown in FIG. 11, from a viewpoint that energy loss is reduced and high density plasma can be radiated, it is preferable to dispose slot holes by shifting the position of each row in a longitudinal direction so that at least one slot hole 41 is present in a width direction of the wall (40b) at the antenna portion 40. For example, in FIG. 11, between slot holes (41A₁) and (41A₂) belonging to the same row, a slot hole (41B₁) of an adjacent row is present in a width direction of the antenna portion 40. Between slot holes (41B₁) and (41B₂) belonging to the same row, a slot hole (41A₂) of an adjacent row is present in a width direction of the antenna portion 40. In this way, it is preferable for slot holes to be arranged so that a surface current crossing an inner side of the wall 40b of the antenna portion 40 in a width direction necessarily crosses one slot hole 41.

In examples of FIG. 10 and FIG. 11, slot holes 41 are not limited to two rows, but three or more rows can be also disposed, and the number of slot holes in one row is also not limited to six.

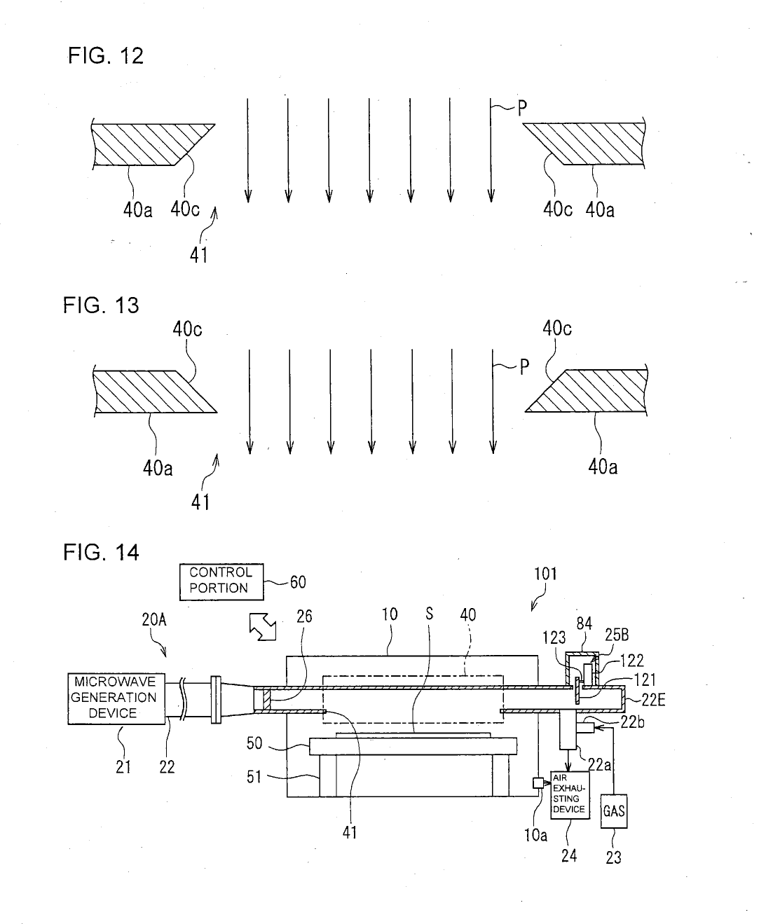

In each construction example of the above slot hole 41, it is preferable for an edge face 40c of an opening of the slot hole 41 to be provided obliquely so that an opening is widened from an inner side to an outer side of the rectangular waveguide tube 22 in a direction of the thickness of the wall (40a) (or wall 40b), as shown by enlargement in FIG. 12. By providing an edge face (40c) of the slot hole 41 as an oblique surface, the width (L3) of an opening portion of the slot hole 41 on an inner wall surface side of the rectangular waveguide tube 22 is shortened. Thus, discharge initiation power is reduced, energy loss is suppressed, and high density plasma is generated. On the other hand, as shown in FIG. 13, when the opening width on an outer side of the rectangular waveguide tube 22 is made to be narrower than the opening width on an inner side (that is, when obliquity is reverse to that of FIG. 12), the effect of widening a discharge region is also obtained. In addition, in FIG. 12 and FIG. 13, farther up the wall (40a) is the interior of the rectangular waveguide tube 22, and a symbol (P) schematically indicates plasma released from the slot hole 41.

A specific shape and an arrangement example of the slot hole 41 are not limited to the above examples. When a waveguide antenna is used, since a standing wave of a microwave formed in the rectangular waveguide tube 22 is utilized upon introduction of a microwave into the rectangular waveguide tube 22, it is advantageous for generating strong plasma if the slot hole 41 is provided at a portion of an antinode of a standing wave. If the slot hole 41 is provided at a portion of a node of a standing wave, the electromagnetic field is weak and plasma is not effectively generated in the slot hole 41. This is because plasma is not produced, or only weak plasma is produced, at a portion of a node of a standing wave formed in the rectangular waveguide tube 22. Therefore, in the plasma generation device 100 of the present embodiment, the phase shifting device (25A) is provided, a phase of a standing wave is made to be shifted, and positions of an antinode and a node of a standing wave are caused to be cyclically moved relative to the slot hole 41, in a longitudinal direction of the rectangular waveguide tube 22. From such a viewpoint, the slot hole 41 is preferred to be shaped so that, even when a position of an antinode of a standing wave is moved, the slot hole 41 is always present at a position of an antinode. It is most preferable for a long single slot hole 41 to be formed over the entire length of the antenna portion 40 as shown in FIG. 7 and FIG. 8. That is, by combining the phase shifting device (25A) and a long simple slot hole 41, uniform line plasma is effectively generated in the slot hole 41 over its entire length.

In the plasma generation device 100, as shown in FIGS. 10 and 11, for example, even when shapes and arrangements of one row or multiple rows of multiple slot holes 41 are employed, plasma is made uniform by time average at the antenna portion 40, by cyclically changing positions of an antinode and a node of a standing wave using the phase shifting device (25A). Therefore, by providing the phase shifting device (25A) as a phase shifting means, the effect of generating uniform plasma in each slot hole 41 is achieved over an entire region of a long antenna portion 40, regardless of the shape and arrangement of the slot hole 41 of the antenna portion 40 of the rectangular waveguide tube 22.

Next, the operation of the plasma processing apparatus 100 is described. First, a workpiece (S) is loaded into a processing container 10 and is placed on a stage 50. Then, a processing gas is introduced into the rectangular waveguide tube 22 from a gas supply device 23 at a predetermined flow rate via a gas introduction portion 22b and a branch tube 22a. By introducing the processing gas into the rectangular waveguide tube 22, pressure in the rectangular waveguide tube 22 becomes greater relative to the outside atmospheric pressure.

Then, the power of the microwave generation device 21 is turned on to generate a microwave. Thereupon, a pulse-type microwave may be generated. A microwave is introduced into the rectangular waveguide tube 22 via a matching circuit, which is not shown. By the introduced microwave, an electromagnetic field is formed in the rectangular waveguide tube 22, and the processing gas supplied into the rectangular waveguide tube 22 is plasmatized in the slot hole 41 of the antenna portion 40. This plasma is radiated through the slot hole 41 toward a workpiece (S) on the outside from the interior of the antenna portion 40 of the rectangular waveguide tube 22, which has relatively high pressure. While a microwave is supplied into the rectangular waveguide tube 22, a driving portion 112 of the phase shifting device (25A) is driven to move a block 111 back and forth, repeatedly advancing into and retracting from the rectangular waveguide tube 22. Thus, a phase of a standing wave in the antenna portion 40 is changed, positions of an antinode and a node are changed cyclically, and line plasma is formed to be uniform by time average in a longitudinal direction of the antenna portion 40.

As described, since the plasma generation device 20 and the plasma processing apparatus 100 provided therewith of the present embodiment have the phase shifting device (25A), positions of an antinode and a node of a standing wave are changed cyclically so that line plasma is generated to be uniform by time average in a longitudinal direction of the antenna portion 40. Accordingly, the process on a workpiece is conducted homogeneously in a longitudinal direction of the antenna portion 40.

Since the plasma processing apparatus 100 is an atmospheric pressure plasma device requiring no vacuum container, a dielectric plate does not need to be provided between the rectangular waveguide tube 22 and the workpiece (S), and loss due to absorption of a microwave with the dielectric plate is prevented. And, since the plasma processing apparatus 100 is an atmospheric pressure plasma device, a pressure-resistant vacuum container and a sealing mechanism are unnecessary, and the device may have simple construction. Further, in the plasma generation device 20 and the plasma processing apparatus 100 provided therewith of the present embodiment, since a processing gas supplied into the rectangular waveguide tube 22 is plasmatized by a microwave in the slot hole 41 and is released to the outside from the slot hole 41, special gas introduction equipment such as a shower head is not necessary, and the size of the device can be reduced. That is, since the rectangular waveguide tube 22 plays the role of shower head, gas introduction equipment such as the shower head and a shower ring does not need to be separately provided, and device structure is simplified.

### Second Embodiment

Next, a plasma processing apparatus of a second embodiment of the present invention is described, referring to FIG. 14 to FIG. 19. FIG. 14 is a diagram schematically showing the plasma processing apparatus 101 of a second embodiment of the present invention. The plasma processing apparatus 101 of FIG. 14 includes a processing container 10; a plasma generation device 20A that generates plasma and releases plasma toward a workpiece (S) in the processing container 10; a stage 50 that supports the workpiece (S); and a control portion 60 that controls the plasma processing apparatus 101 and is an atmospheric pressure plasma processing apparatus that conducts processing on the workpiece (S) at a normal pressure. Herein, the plasma generation device 20A includes a microwave generation device 21 that generates a microwave; a rectangular waveguide tube 22 that is connected to the microwave generation device 21 and in which an antenna portion 40 is provided as a part thereof; a gas supply device 23 that is connected to the rectangular waveguide tube 22 and supplies a processing gas into the interior thereof; an air exhausting device 24 that exhausts a gas in the antenna portion 40 and the air in the processing container 10; a phase shifting device 25B as a phase shifting means that cyclically shifts a phase of a standing wave in the rectangular waveguide tube 22 (particularly, in the antenna portion 40); and a partition 26 formed of a dielectric such as quartz for blocking passage of the processing gas in the interior of the rectangular waveguide tube 22. In addition, a slot hole 41 is formed on one wall surface of the rectangular waveguide tube 22, and a region in which the slot hole 41 is formed corresponds to an antenna portion 40 that releases plasma generated in the slot hole 41 toward the workpiece (S) on the outside.

The plasma processing apparatus 101 of the present embodiment (FIG. 14) and the plasma processing apparatus 100 of the first embodiment (FIG. 1) differ in that a phase shifting device (25B) is provided in place of the phase shifting device (25A). Therefore, the following descriptions focus on the difference, and the same reference numbers apply to the elements identical to those described above, and their descriptions are omitted here.

### Phase Shifting Device

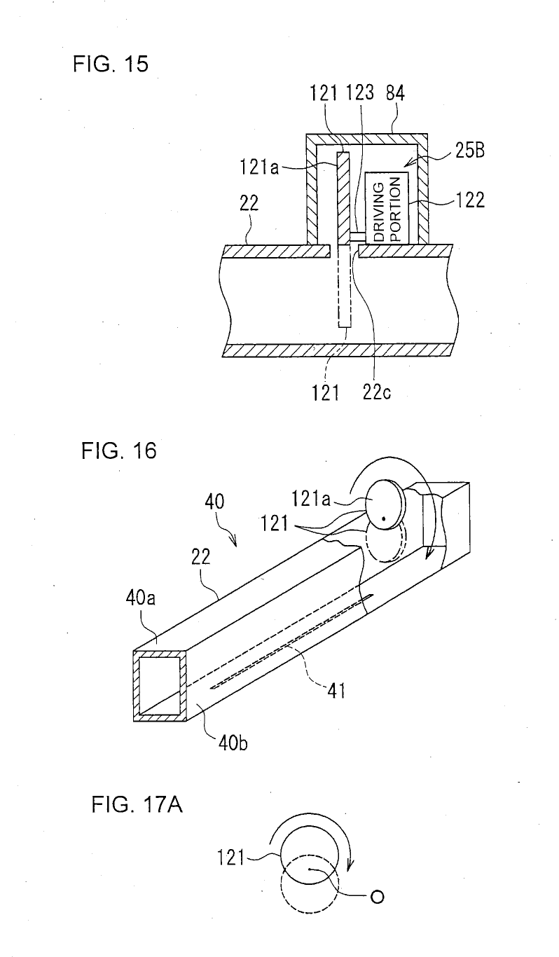

The phase shifting device (25B) of the present embodiment has a wall member that performs rotational motions around an axis set in a direction corresponding to a longitudinal direction of the rectangular waveguide tube 22. Specifically, as shown in FIG. 15 and FIG. 16, the phase shifting device (25B) includes a rotor 121 as a “wall member that performs rotational motions around an axis set in a direction corresponding to a longitudinal direction of the rectangular waveguide tube 22,” a driving portion 122 that rotates rotor 121, and an axis member 123 that supports the rotor 121 and, at the same time, connects the rotor 121 and the driving portion 122 to transmit a motive power of the driving portion 122 to the rotor 121. The driving portion 122 rotates the rotor 121, and cyclically advances and retracts one or multiple portions of the rotor 121 into or from the rectangular waveguide tube 22 through an insertion opening (22c) provided in the rectangular waveguide tube 22. The driving portion 122 can be constructed of, for example, a motor or the like. The axis member 123 is positioned on an outer side of the rectangular waveguide tube 22.

### Rotor

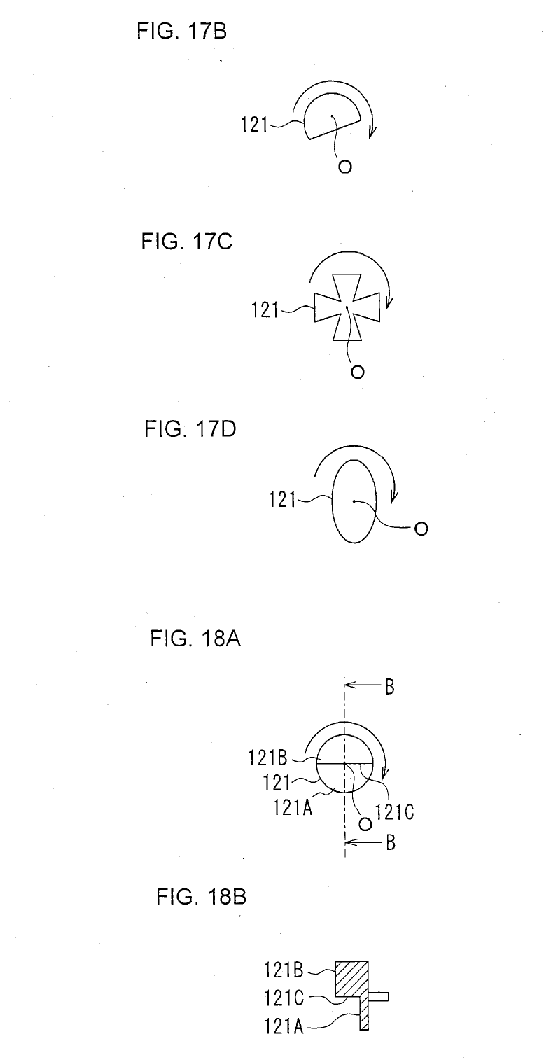

The rotor 121 has a wall surface 121a that faces a microwave propagating through the rectangular waveguide tube 22. The shape of the rotor 121 is shown in FIGS. 17A to 17D. In FIGS. 17A to 17D, a symbol (O) is a rotation center connected to an axis member 123. As shown in FIG. 17A, when the rotor 121 has a shape close to a perfect circle, the axis member 123 which transmits rotational motion to the rotor 121 is connected in a portion away from the center of the rotor 121. Thus, when the rotor 121 rotates around a position of the axis member 123 as a rotation center (O), a part of the rotor 121 advances into and retracts from the rectangular waveguide tube 22 cyclically. In addition, the rotational direction of the rotor 121 may be to the left or right, and the rotational direction may be changed.

The rotor 121 can have a shape that is non-uniform in a rotational direction and, for example, as shown in FIG. 17B, the shape may be fan-like, where part of a circle is lacking, as shown in FIG. 17C, wing-like (propeller-like), or as shown in FIG. 17D, elliptical, or although diagrammatic representation is omitted, the shape may be oblong, triangular, star-shaped or the like. As described, by employing a shape that is non-uniform in a rotational direction, when the rotor rotates around a position of the axis member 123 as a rotation center (O), one or multiple portions of the rotor 121 advances into and retracts from the rectangular waveguide tube 22 cyclically. In addition, as the rotor 121, as shown in FIGS. 18A and 18B, a rotor having a thickness different in a longitudinal direction of the rectangular waveguide tube 22 can be also used. That is, the rotor 121 shown in FIGS. 18A and 18B is such that its thickness is non-uniform in a rotational axis direction and has a first wall surface (121A), a second wall surface (121B) which protrudes in a direction opposite a progression direction of a microwave more than first wall surface (121A), and a step portion (121C) formed between the first and second wall surfaces (121A, 121B). Also, the rotor 121 having the first and second wall surfaces (121A, 121B) rotates around an axis set in a direction corresponding to a longitudinal direction in the rectangular waveguide tube 22. Thus, a portion of the first wall surface (121A) and a portion of the second wall surface (121B) alternately advance into and retract from the rectangular waveguide tube 22, thereby transmitting and/or reflecting a microwave. As a result, positions of an antinode and a node of a standing wave generated in the rectangular waveguide tube 22 can be cyclically changed so that a phase of the standing wave is cyclically changed. In addition, not only two, but also three or more thicknesses of the rotor 121 may be provided at different positions in a longitudinal direction of the rectangular waveguide tube 22. Alternatively, the thickness of the rotor 121 may be changed gradually instead of step by step. Alternatively, a portion of the first wall surface (121A) and a portion of the second wall surface (121B) may be formed of different materials (e.g. a dielectric and a metal, or materials having different dielectric constants).

Concerning the rotor 121, it is thought that, when an accumulated area of insertion into the rectangular waveguide tube 22 (herein, a time-integrated area of a wall surface 121a, first and second wall surfaces 121A and 121B which are inserted into the rectangular waveguide tube 22) is too small, transmission and reflection become difficult to achieve, and when the area is too great, in the case where the actual insertion amount deviates from a set insertion amount and increases, the rotor 121 is damaged by being contacted and rubbed by the inner surface of the rectangular waveguide tube 22.

It is preferable for a period of rotational motion, one cycle being an action of rotating the rotor 121 one time, to be 1/1000 to ½ of a plasma processing process time, from the viewpoint of uniformity of a plasma processing process, throughput and simplification of a driving mechanism.

As described, the phase shifting device (25B) operates the driving portion 122 to rotate the rotor 121 around an axis set in a direction corresponding to a longitudinal direction of the rectangular waveguide tube 22, and cyclically inserts and retracts one or multiple portions of rotor 121 into and out of the rectangular waveguide tube 22. By so doing, the phase shifting device (25B) cyclically shifts a phase of a standing wave in a longitudinal direction of the rectangular waveguide tube 22. Namely, when the rotor 121 has a shape that is non-uniform in a rotational direction as shown in FIGS. 17A to 17D, when part of the rotor 121 is inserted into the rectangular waveguide tube 22, since transmission and/or reflection of a microwave are generated by the rotor 121, positions of an antinode and a node of a standing wave generated in the rectangular waveguide tube 22 are moved. On the other hand, when the rotor 121 is retracted from the rectangular waveguide tube 22, since transmission and/or reflection are not generated by the rotor 121, a phase of a standing wave returns to its original state where a reflected wave is generated at an end portion (22E) of the rectangular waveguide tube 22, and positions of an antinode and a node of a standing wave are recovered as before. In addition, when the rotor 121 has a shape whose thickness is non-uniform in a rotational axis direction as shown in FIGS. 18A and 18B, a portion of a first wall surface (121A) and a portion of a second wall surface 121B alternately advance into and retract from the rectangular waveguide tube 22, thereby transmitting and/or reflecting a microwave. As a result, positions of an antinode and a node of a standing wave generated in the rectangular waveguide tube 22 are changed cyclically so that a phase of the standing wave is changed cyclically. Therefore, the rotor 121 is rotated, and positions of an antinode and a node of a standing wave are moved cyclically by repeatedly advancing and retracting a part thereof into and out of the rectangular waveguide tube 22. In a slot hole 41, line plasma is generated to be uniform by time average in a longitudinal direction of the antenna portion 40. Therefore, the process on a workpiece is conducted homogeneously in a longitudinal direction of the antenna portion 40.

### Modified Example of Second Embodiment

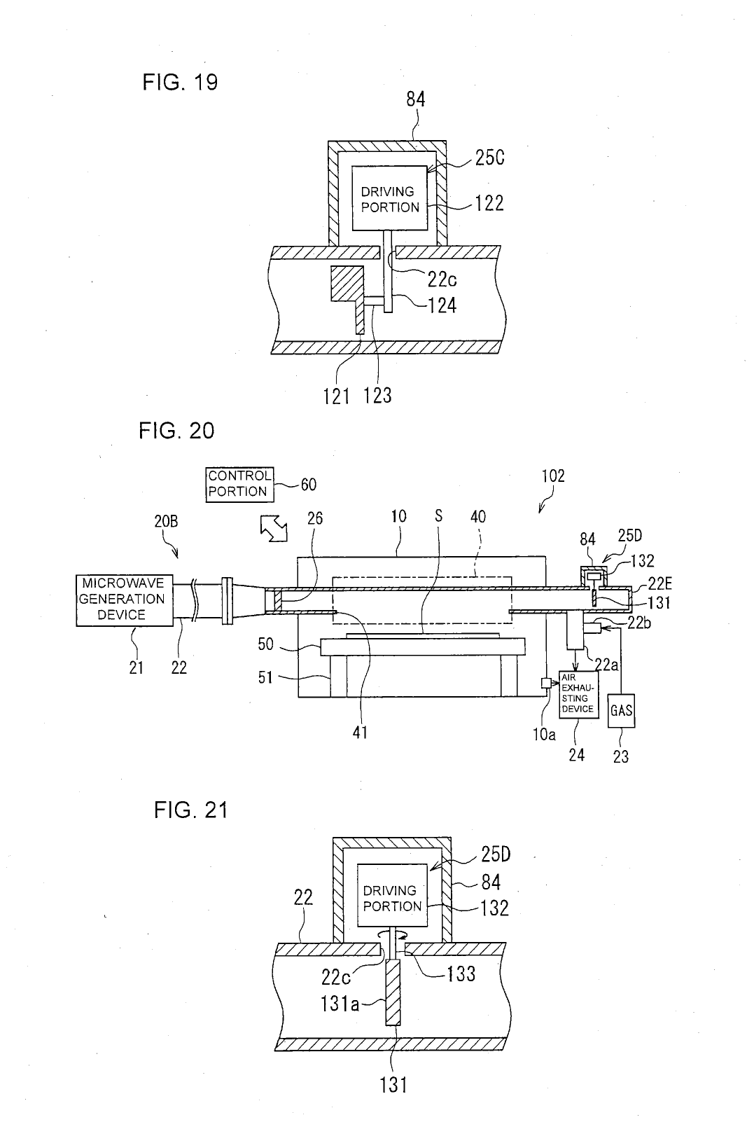

In FIG. 14 to FIG. 16, an example shows an axis member 123 becoming a rotational axis (i.e. rotation center 0) positioned on an outer side of the rectangular waveguide tube 22, but the axis member 123 also can be arranged in the rectangular waveguide tube 22. For example, as shown in FIG. 19, a phase shifting device (25C) as a phase shifting means includes a rotor 121, a driving portion 122 that rotates rotor 121, and a connecting member 124 that supports rotor 121 and, at the same time, connects an axis member 123 arranged on an inner side of the rectangular waveguide tube 22, the axis member 123 and the driving portion 122 to convey the motive power from the driving portion 122 to the axis member 123 via an insertion opening (22c).

In the present modified example, as the rotor 121, a rotor 121 whose thickness is non-uniform in a rotational axis direction as shown in FIGS. 18A and 18B is preferred to be used. Also, by rotating the rotor 121 having first and second wall surfaces (121A, 121B) in a direction consistent with a longitudinal direction thereof as a rotational axis in the rectangular waveguide tube 22, a microwave is transmitted and/or reflected alternately at a portion of the first wall surface (121A) and a portion of the second wall surface (121B).

As a result, a phase of a standing wave generated in the rectangular waveguide tube 22 is cyclically changed.

In the phase shifting device (25C) of the present modified example, as shown in FIGS. 18A and 18B, a rotor in which multiple members (e.g. plate materials) are arranged by changing a position also can be used in place of the rotor 121 whose thickness is non-uniform in a rotational axis direction, so that multiple wall surfaces that reflect a microwave are formed at different positions in a longitudinal direction of the rectangular waveguide tube 22 (no shown in the drawings). In this case, since a reflection position of a microwave is changed in a longitudinal direction of the rectangular waveguide tube 22 by rotating the rotor having multiple plate materials formed of, for example, a metal, a phase of a standing wave generated in the rectangular waveguide tube 22 cyclically changes. In addition, in the phase shifting device (25C) of the present modified example, as the rotor 121, as shown in FIGS. 17A to 17D, a rotor having a shape which is non-uniform in a rotational direction can be also used. In the present modified example, when the rotor 121 shown in FIGS. 17A to 17D is used, by rotating the rotor in the rectangular waveguide tube 22 around a rotational axis set in a direction corresponding to a longitudinal direction thereof, transmission and/or reflection due to the rotor 121 are cyclically generated due to the shifted rotation center (O) and non-uniformity of a shape in a rotational direction. Accordingly, a phase of a standing wave is cyclically shifted.

In the second embodiment, the rotor 121 is not limited to those shown in FIGS. 17A to 17D and FIGS. 18A and 18B, and may have any shape as long as it is a shape that can cyclically displace a wall surface 121a (121A, 121B) that faces a microwave propagating through the rectangular waveguide tube 22.

In the present embodiment, a material of the rotor 121 and positions on which the phase shifting devices 25B and 25C are disposed may be the same as those of the first embodiment. Also, in order to prevent a microwave from leaking to the outside through an insertion opening (22c), it is preferable to cover the phase shifting devices (25B, 25C) with a cover member 84, as in the first embodiment. The rest of the structure and its effect according to the present embodiment are the same as those of the first embodiment.

### Third Embodiment

Next, a plasma processing apparatus of a third embodiment of the present invention will be explained, referring to FIG. 20 to FIG. 22B. FIG. 20 is a schematic construction diagram of a plasma processing apparatus 102 of a third embodiment of the present invention. The plasma processing apparatus 102 of FIG. 20 includes a processing container 10; a plasma generation device 20B that generates plasma and releases plasma toward a workpiece (S) in the processing container 10; a stage 50 that supports the workpiece (S); and a control portion 60 that controls the plasma processing apparatus 102 and is an atmospheric-pressure plasma treating device that performs processing on the workpiece (S) at a normal pressure. Herein, the plasma generation device 20B includes a microwave generation device 21 that generates a microwave; a rectangular waveguide tube 22 that is connected to the microwave generation device 21 and in which an antenna portion 40 is provided as a part thereof; a gas supply device 23 that is connected to the rectangular waveguide tube 22 and supplies a processing gas into the interior thereof; an air exhausting device 24 that exhausts a gas in the antenna portion 40 and, optionally, the air in the processing container 10; a phase shifting device (25D) as a phase shifting means that cyclically shifts a phase of a standing wave in the rectangular waveguide tube 22 (particularly, in the antenna portion 40); and a partition 26 formed of a dielectric such as quartz for blocking passage of the processing gas in the interior of the rectangular waveguide tube 22. Also, a slot hole 41 is formed on one wall surface of the rectangular waveguide tube 22, and a region in which the slot hole 41 is formed corresponds to an antenna portion 40 which releases plasma generated in the slot hole 41 toward a workpiece (S) on the outside.

The plasma processing apparatus 102 of the present embodiment (FIG. 20) and the plasma processing apparatus 100 of the first embodiment (FIG. 1) differ in that the phase shifting device (25D) is provided in place of the phase shifting device (25A). Therefore, the following descriptions focus on the difference, and the same reference numbers apply to the elements identical to those described above, and their descriptions are omitted here.

### Phase Shifting Device

The phase shifting device (25D) of the present embodiment has a wall member that performs rotational motions around an axis set in a direction crossing (preferably, a direction orthogonal to) a longitudinal direction of the rectangular waveguide tube 22. Specifically, as shown in FIG. 21 by enlargement, the phase shifting device (25D) includes a rotor 131 as a “wall member that performs rotational motions around an axis set in a direction crossing a longitudinal direction of the rectangular waveguide tube 22,” a driving portion 132 that rotates the rotor 131, and an axis member 133 that supports the rotor 131 and, at the same time, connects the rotor 131 and the driving portion 132 via an insertion opening (22c) provided in the rectangular waveguide tube 22 to transmit a motive power of the driving portion 132 to the rotor 131. The driving portion 132 rotates the rotor 131 around an axis set in a direction crossing a longitudinal direction of the rectangular waveguide tube 22. The driving portion 132 is constructed of, for example, a motor or the like.

### Rotor

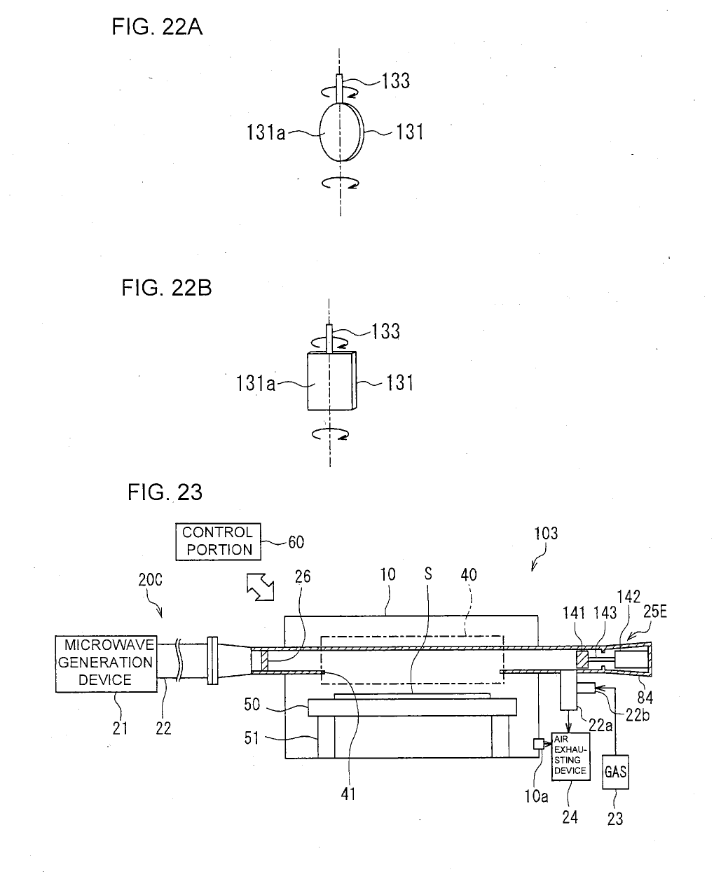

The rotor 131 has a wall surface (131a) that cyclically faces a microwave propagating through the rectangular waveguide tube 22. In addition, both sides of a plate-like rotor 131 may be utilized as the wall surface (131a) that cyclically faces a microwave. The shape of the rotor 131 is not particularly limited, but for example, as shown in FIG. 22A, the shape may be a thin circular plate. As shown in FIG. 22B, the shape may be that of a thin rectangular plate. By rotating the rotor 131 in the rectangular waveguide tube 22 in a direction crossing (e.g. orthogonal to) a longitudinal direction thereof, a phase of a standing wave of a microwave generated in the rectangular waveguide tube 22 can be cyclically shifted.

That is, since at such an angle that the wall surface (131a) of the rotor 131 is orthogonal to a longitudinal direction of the rectangular waveguide tube 22 (i.e. progression direction of microwave), transmission and/or reflection of a microwave are generated by the rotor 131, a phase of a standing wave generated in the rectangular waveguide tube 22 is shifted, and positions of an antinode and a node are moved. On the other hand, since at such an angle that the wall surface (131a) of the rotor 131 becomes parallel to a longitudinal direction of the rectangular waveguide tube 22, the thickness of the rotor 131 is small, transmission and reflection of a microwave are reduced to an approximately negligible level, a phase of a standing wave is returned to its original state where a reflected wave is generated at an end portion (22E) of the rectangular waveguide tube 22, and positions of an antinode and a node are also recovered. Therefore, by rotating the rotor 131 in the rectangular waveguide tube 22, a phase of a standing wave is cyclically shifted, positions of an antinode and a node are cyclically moved, and line plasma is generated to be uniform by time average in a longitudinal direction of the antenna portion 40. As a result, the process on a workpiece is conducted homogeneously in a longitudinal direction of the antenna portion 40.

In the present embodiment, the shape of the rotor 131 is not limited to those shown in FIGS. 22A and 22B because it is enough that the rotor 131 has wall surfaces (131a) that face a microwave propagating through the rectangular waveguide tube 22. And, in the present embodiment, in order to enhance controllability as positions of an antinode and a node of a standing wave are moved, for example, a mechanism such as a stepping motor or the like that can control a rotational angle can be adopted in the driving portion 132. In this case, the rotor 131 is rotated at a predetermined angle relative to a longitudinal direction of the rectangular waveguide tube 22, for example, at every 90°.

When an area of the wall surface (131a) that faces a microwave propagating through the rectangular waveguide tube 22 is too small, transmission and reflection are difficult to achieve, and when the area is too large, problems such as displacement or damage may arise.

It is preferable for a period of rotational movement, one cycle being the action of a 360° rotation of a rotor 131 in the rectangular waveguide tube 22, to be 1/1000 to ½ of a plasma processing process time, from the viewpoint of the uniformity of a plasma processing process, throughput, and simplification of a driving mechanism.

In the present embodiment, a material of the rotor 131 and the disposition position of the phase shifting device (25D) can be the same as those of the first embodiment. Since the rotational axis of the rotor 131 may be positioned in any direction as long as it crosses a longitudinal direction of the rectangular waveguide tube 22, for example, a rotational axis of the rotor 131 may be provided in a direction vertical or horizontal to the rectangular waveguide tube 22 that is set long in a horizontal direction. Also, in order to prevent a microwave from leaking to the outside through an insertion opening (22c), it is preferable for the phase shifting device (25D) to be covered with a cover member 84, as in the first embodiment. The rest of the structure and its effect according to the present embodiment are the same as those of the first embodiment.

### Fourth Embodiment

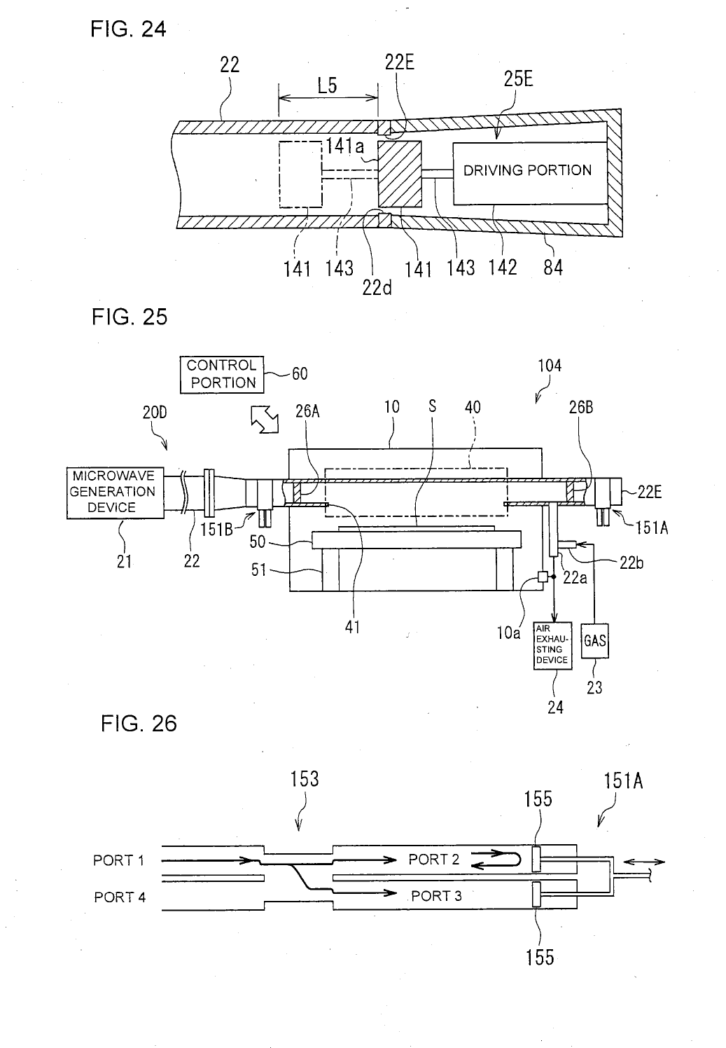

Next, a plasma processing apparatus of a fourth embodiment of the present invention will be explained, referring to FIG. 23 and FIG. 24. FIG. 23 is a schematic construction diagram of a plasma processing apparatus 103 of a fourth embodiment of the present invention. The plasma processing apparatus 103 of FIG. 23 includes a processing container 10; a plasma generation device (20C) that generates plasma and releases plasma toward a workpiece (S) in the processing container 10; a stage 50 that supports the workpiece (S); and a control portion 60 that controls the plasma processing apparatus 103 and is an atmospheric pressure plasma processing apparatus that conducts processing on the workpiece (S) at a normal pressure. Here, the plasma generation device (20C) includes a microwave generation device 21 that generates a microwave; a rectangular waveguide tube 22 that is connected to the microwave generation device 21 and in which an antenna portion 40 is provided as a part thereof; a gas supply device 23 that is connected to the rectangular waveguide tube 22 and supplies a processing gas into its interior; an air exhausting device 24 for exhausting a gas in the antenna portion 40 and, optionally, the air in the processing container 10; a phase shifting device (25E) as a phase shifting means that cyclically shifts a phase of a standing wave in the rectangular waveguide tube 22 (particularly, in the antenna portion 40); and a partition 26 made of a dielectric such as quartz for blocking passage of the processing gas inside the rectangular waveguide tube 22. Also, a slot hole 41 is formed on one wall surface of the rectangular waveguide tube 22, and a region in which the slot hole 41 is formed corresponds to the antenna portion 40, which releases plasma generated in the slot hole 41 toward the workpiece (S) on the outside.

The plasma processing apparatus 103 of the present embodiment (FIG. 23) and the plasma processing apparatus 100 of the first embodiment (FIG. 1) differ in that the phase shifting device (25E) is provided in place of the phase shifting device (25A). Therefore, the following descriptions focus on the difference, and the same reference numbers apply to the elements identical to those described above, and their descriptions are omitted here.

### Phase Shifting Device

A phase shifting device (25E) of the present embodiment has a wall member that faces a microwave propagating through the rectangular waveguide tube 22. This wall member is provided at an end portion of the rectangular waveguide tube 22 and moves back and forth, advancing into and retracting from the rectangular waveguide tube 22 in a longitudinal direction. Specifically, as shown in an enlarged view in FIG. 24, the phase shifting device (25E) includes a plunger-like movable body 141 as a “wall member that moves back and forth, advancing into and retracting from the rectangular waveguide tube 22 in a longitudinal direction,” a driving portion 142 that shuttles movable body 141 back and forth in a linear line, and a shaft 143 that supports the movable body 141 and, at the same time, connects it to a driving portion 142. In the present embodiment, the movable body 141 is made of a metal and has a rectangular wall surface (141a) that is approximately analogous to a cross section of the rectangular waveguide tube 22. This wall surface (141a) faces a microwave propagating through the rectangular waveguide tube 22 and generates a reflected wave, and is formed to be slightly smaller than a lengthwise and crosswise inner diameter of the rectangular waveguide tube 22.

The driving portion 142 cyclically shuttles the movable body 141 back and forth in a linear line in a longitudinal direction of the rectangular waveguide tube 22. The driving portion 142 causes the shaft 143 and the movable body 141 to advance into and retract from the rectangular waveguide tube 22 along a predetermined distance L5, via an insertion opening 22d provided at an end portion (22E) of the rectangular waveguide tube 22. When retracted, a most of the movable body 141 is moved to the outside of the rectangular waveguide tube 22 through the insertion opening 22d, and retracts until the wall surface (141a) reflecting a microwave aligns with an inner wall surface of the end portion (22E) of the rectangular waveguide tube 22. The driving portion 142 may be formed with, for example, an air cylinder, an oil hydraulic cylinder or the like, or may be formed by combining a driving source such as a motor or the like with a crank mechanism, a Scotch yoke mechanism, a rack and pinion mechanism or the like. In this way, the phase shifting device (25E) shuttles the movable body 141 back and forth in a linear line in a longitudinal direction of the rectangular waveguide tube 22 by actuating the driving portion 142 so that the wall surface (141a) to reflect a microwave is moved. Thus, a phase of a standing wave generated in the rectangular waveguide tube 22 is shifted cyclically.

Namely, when the movable body 141 has advanced into the rectangular waveguide tube 22, since a microwave is reflected by the wall surface (141a) of the movable body 141 which has advanced a distance L5, the waveguide length of the rectangular waveguide tube 22 is substantially shortened. Accordingly, positions of an antinode and a node of a standing wave generated in the rectangular waveguide tube 22 are moved. On the other hand, in a state where the wall surface (141a) of the movable body 141 has retracted to the original end portion (22E) of the rectangular waveguide tube 22, the waveguide length becomes the original length, and positions of an antinode and a node of a standing wave are recovered as before. Therefore, by repeating an action of advancing and retracting the movable body 141 into and out of the rectangular waveguide tube 22, positions of an antinode and a node of a standing wave are moved cyclically, and line plasma is generated to be uniform by time average in a longitudinal direction of the antenna portion 40. As a result, the process on a workpiece is conducted homogeneously in a longitudinal direction of the antenna portion 40.

The above non-patent publication describes a plasma generation device in which a movable plunger is provided at an end portion of a rectangular waveguide tube. However, since the device of Non-Patent Reference 1 is not an atmospheric pressure plasma device, it is greatly different technically from the present invention. Also, in order to study a waveguide length that can generate stable plasma, the plunger of Non-Patent Reference 1 was devised merely to simplify changing a position of a fixed end of a rectangular waveguide tube. Therefore, unlike the plasma processing apparatus 103 of the present embodiment, the device described in Non-Patent Reference 1 does not have the function of moving a reflection position of a microwave cyclically while plasma is generated so as to change a phase of a standing wave and to generate line plasma to be uniform by time average.

In the present embodiment, the movable body 141 is not limited to the shape shown in FIG. 24, and may be any as long as necessary to move a reflection position of a microwave cyclically to displace positions of an antinode and a node of a standing wave in a longitudinal direction of the rectangular waveguide tube 22. Also, when an area of a wall surface (141a), which faces a microwave propagating through the rectangular waveguide tube 22 and generates a reflected wave, is too small, reflection at the wall surface (141a) is hard to achieve. Thus, it is preferable for the ratio of an area of the wall surface (141a) relative to a cross-sectional area of the rectangular waveguide tube 22 (area of wall surface (141a)/cross-sectional area of rectangular waveguide tube 22) to be infinitely close to 1.

A distance (L5) by which the movable body 141 of the phase shifting device (25E) advances is not limited specifically. However, by setting a position of the wall surface (141a) at a position of an antinode of a standing wave originally generated in a rectangular waveguide tube 22 when the movable body 141 has been advanced, it is easier to move positions of an antinode and a node of a standing wave. Here, since a node of the original standing wave generated in the rectangular waveguide tube 22 corresponds to an inner wall surface of an end portion (22E) of the rectangular waveguide tube 22 that is a fixed end, it is preferable for the length (L5) by which the movable body 141 is advanced to be set to be n×λg/4 relative to the intratubular wavelength λg of a standing wave (here, “n” means a positive odd integer, preferably 1), between an end portion (40E) of the antenna portion 40 and an end portion (22E) of the rectangular waveguide tube 22.

When one cycle is set for advancing and retracting the movable body 141 into and out of the rectangular waveguide tube 22, it is preferable for a period of shuttling movable body 141 back and forth in a linear line to be 1/1000 to ½ of a plasma processing processing time, in view of the uniformity of a plasma processing process, throughput, and simplification of a driving mechanism.

To prevent a microwave from leaking to the outside through an insertion opening (22d), it is also preferable in the present embodiment to cover the phase shifting device (25E) with a cover member 84. The rest of the structure and its effect according to the present embodiment are the same as those of the first embodiment.

### Fifth Embodiment

In the following, a plasma processing apparatus of a fifth embodiment of the present invention is described by referring to FIG. 25 and FIG. 26. FIG. 25 is a diagram schematically showing the structure of a plasma processing apparatus 104 of the fifth embodiment of the present invention. The plasma processing apparatus 104 of FIG. 25 includes a processing container 10; a plasma generation device (20D) that generates plasma and releases plasma toward a workpiece (S) in the processing container 10; a stage 50 that supports the workpiece (S); and a control portion 60 that controls the plasma processing apparatus 104 and is structured as an atmospheric pressure plasma processing apparatus that conducts processing on the workpiece (S) at a normal pressure. Here, the plasma generation device (20D) includes a microwave generation device 21 that generates a microwave; a rectangular waveguide tube 22 that is connected to the microwave generation device 21 and in which an antenna portion 40 is provided as a part thereof; a gas supply device 23 that is connected to the rectangular waveguide tube 22 and supplies a processing gas into the interior thereof; an air exhausting device 24 for exhausting a gas in the antenna portion 40 and the air in the processing container 10 if necessary; one pair of phase shifters (151A, 151B) as a phase shifting means that cyclically shifts a phase of a standing wave in the rectangular waveguide tube 22 (particularly, in the antenna portion 40); and one pair of partitions (26A, 26B) made of a dielectric such as quartz for blocking passage of the processing gas in the interior of the rectangular waveguide tube 22. In addition, the partition (26B) on an end portion (22E) side of the rectangular waveguide tube 22 may be omitted. Also, a slot hole 41 is formed on one wall surface of the rectangular waveguide tube 22, and a region in which the slot hole 41 is formed corresponds to the antenna portion 40 that releases plasma generated in the slot hole 41 toward the workpiece (S) on the outside.

The plasma processing apparatus 104 of the present embodiment (FIG. 25) and the plasma processing apparatus 100 of the first embodiment (FIG. 1) differ mainly in that one pair of phase shifters (151A, 151B) as a phase shifting means is provided in place of the phase shifting device (25A). Therefore, the following descriptions focus on the difference, and the same reference numbers apply to the elements identical to those described above, and their descriptions are omitted here.

### Phase Shifter

In the present embodiment, one pair of phase shifters (151A, 151B), which are a phase shifting means, sandwich the antenna portion 40 therebetween and are provided on both sides thereof. Namely, the phase shifter (151A) is disposed farther on an end portion (22E) side of the rectangular waveguide tube 22 than the antenna portion 40, and the phase shifter (151B) is disposed farther on a microwave generation device 21 side of the rectangular waveguide tube 22 than the antenna portion 40. Phase shifters (151A, 151B) are respectively connected to the rectangular waveguide tube 22 and form a part of the waveguide.

Both of the phase shifters (151A, 151B) have the same structure. An example of the structure of the phase shifter (151A) is schematically shown in FIG. 26. The phase shifter (151A) includes, for example, a directional coupler 153 and two variable short-circuiting bars (155, 155). Here, in the phase shifter (151A), a connecting portion with the rectangular waveguide tube 22 on a microwave generation device 21 side is set as an incoming port 1; the sides where two space variable short-circuiting bars (155, 155) are positioned are set as a port 2 and a port 3; and a connecting portion with the rectangular waveguide tube 22 on an end portion (22E) side of the rectangular waveguide tube 22 is set as an exiting port 4. In this case, a reflection coefficient S₁₁ at the port 1 represented by an S parameter is a sum of (S₁₂₁) and (S₁₃₁), and is obtained by the following formula (1). Also, a transmission coefficient (S₄₁) from the port 1 to the port 4 is a sum of (S₁₂₄) and (S₁₃₄), and is obtained by the following formula (2).

Math 1

As described above, by using the phase shifter (151A), electric power transmission from the port 1 to the port 4 is conducted without loss. Alternatively, when a connecting portion between the rectangular waveguide tube 22 on an end portion (22E) side of the rectangular waveguide tube 22 is set as an incoming port, and a connecting portion between the rectangular waveguide tube 22 on a microwave generation device 21 side is set as an exiting port, electric power transmission is also conducted without loss. In addition, this is also true of the phase shifter (151B).

Two variable short-circuiting bars (155, 155) are structured to advance into or retract from the waveguide synchronously by a driving portion such as a motor or the like, which is not shown. By advancing and retracting the variable short-circuiting bar 155, a phase of a microwave can be regulated variably. By repeatedly advancing and retracting two each variable short-circuiting bars (155, 155) in the phase shifter (151A) or (151B), positions of an antinode and a node of a standing wave are moved cyclically, and line plasma is generated to be uniform by time average in a longitudinal direction of the antenna portion 40. As a result, the process on a workpiece is conducted homogeneously in a longitudinal direction of the antenna portion 40. Also, in the plasma processing apparatus 104 of the present embodiment, phase shifters (151A, 151B) are actuated in a reverse phase. Herein, “actuated in a reverse phase” means that phase shifters (151A, 151B) are actuated so that a shift in a phase generated by the phase shifter (151A) is canceled by the phase shifter (151B).

In the present embodiment, driving the variable short-circuiting bar 155 of the phase shifter (151A) and driving the variable short-circuiting bar 155 of the phase shifter (151B) are controlled simultaneously so that they are actuated in a reverse phase, and a shift in a phase generated by the phase shifter (151A) is canceled by the phase shifter (151B). Namely, while positions of an antinode and a node of a standing wave in the antenna portion 40 are moved cyclically by the phase shifter (151A), a shift in a phase of a reflected wave that propagates toward the microwave generation device 21 side is corrected by the phase shifter (151B). When a phase of a standing wave in the rectangular waveguide tube 22 is changed only by the phase shifter (151A), complex impedance matching needs to be conducted on the microwave generation device 21 side, due to a reflected wave having a changed phase. However, if the phase shifter (151B) is provided in addition to the phase shifter (151A) and these two are actuated in a reverse phase, the phase shifters (151A, 151B) appear as if they were not present when seen from the microwave generation device 21 side. Thus, impedance matching is simplified. As described, in the present embodiment, two phase shifters (151A) and (151B) are actuated in a reverse phase, while positions of an antinode and a node of a standing wave are moved cyclically, thus reducing the load on an electric source portion 31 (see FIG. 2) of the microwave generation device 21 and on an impedance matching transformer (not shown), and maximizing electric power transmission of a microwave. Accordingly, processing efficiency by atmospheric pressure plasma is enhanced.

The rest of the structure and its effect according to the present embodiment are the same as those of the first embodiment.

### Sixth Embodiment

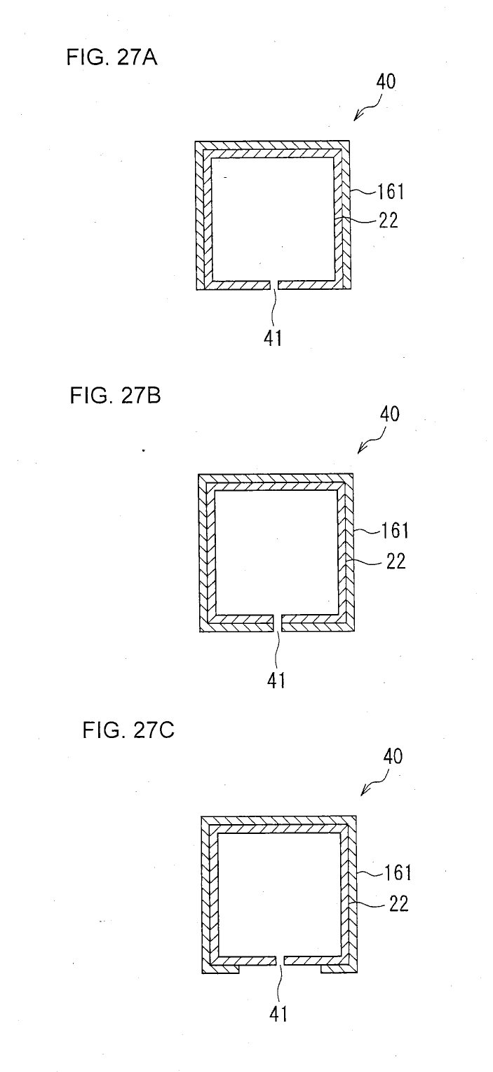

In plasma processing apparatus (100, 101, 102, 103 and 104) of the first to fifth embodiments, a temperature regulating device can be provided in the rectangular waveguide tube 22 in plasma generation devices (20, 20A, 20B, 20C and 20D) respectively. Specific examples in which the temperature regulating device is provided in the rectangular waveguide tube 22 are shown in FIGS. 27A, 27B and 27C. FIG. 27A is an aspect in which a temperature regulating device 161 is provided so as to cover the surrounding three walls of the antenna portion 40 except for a wall on which a slot hole 41 is formed. FIG. 27B is an aspect in which the temperature regulating device 161 is provided so as to cover the entire surface of the antenna portion 40 except for an opening portion of the slot hole 41. FIG. 27C is an aspect in which the temperature regulating device 161 is provided so as to cover three walls of the antenna portion 40, excluding a wall on which the slot hole 41 is formed, and to cover a wall of the antenna portion 40 on which the slot hole 41 is formed while excluding a portion where slot hole 41 is formed. Alternatively, the temperature regulating device 161 may be provided in a portion other than the antenna portion 40 of the rectangular waveguide tube 22.

In the present embodiment, the temperature regulating device 161 may be structured in such a way that a heat medium for cooling or heating, for example, is supplied to circulate in the interior, or may be structured with a heater by resistance heating or the like. Since the temperature of the rectangular waveguide tube 22 including the antenna portion 40 can be regulated by the temperature regulating device 161, relative to changes in the temperature of the rectangular waveguide tube 22 (particularly, antenna portion 40) caused by plasma discharge, safety and reproducibility of plasma discharge can be enhanced.

The rest of the structure and its effect according to the present embodiment are the same as those of the first to fifth embodiments.

### Seventh Embodiment

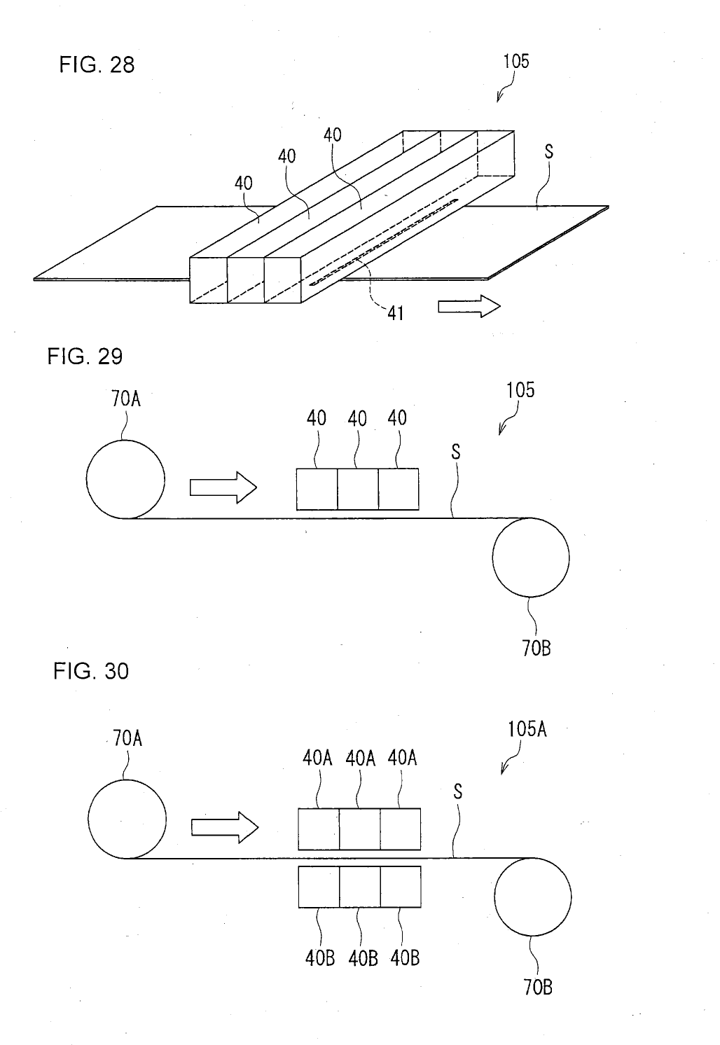

Using plasma generation devices (20, 20A, 20B, 20C and 20D) of the first to fifth embodiments, it is an option to form a plasma processing apparatus 105 in which multiple (3 in FIG. 28) antenna portions 40 of the rectangular waveguide tube 22 are arranged parallel, for example, as shown in FIG. 28. Since structures of plasma generation devises (20, 20A, 20B, 20C and 20D) including the antenna portion 40 are the same as those of the first to fifth embodiments, their detailed descriptions and drawings are omitted here. In addition, as in the sixth embodiment, the temperature regulating device 161 may be provided in the rectangular waveguide tube 22 including the antenna portion 40. In the plasma processing apparatus 105, a workpiece (S) is provided so that it can be moved relative to the antenna portion 40 by a driving mechanism not shown, in a direction indicated by an arrow in FIG. 28. A longitudinal direction of the antenna portion 40 (rectangular waveguide tube 22) and a movement direction of the workpiece (S) are arranged so as to be orthogonal to each other. A slot hole 41 of the antenna portion 40 is disposed at a length greater than the width of the workpiece (S).

As shown in FIG. 28, by arranging multiple antenna portions 40 parallel, and moving the workpiece (S) relative to those antenna portions 40, plasma processing is performed to be uniform in an advancing direction of the workpiece (S). Also, by using phase shifting devices (25A) to (25E) as a phase shifting means, plasma processing is performed to be uniform by time average in a width direction of the workpiece (S) (longitudinal direction of antenna portion 40). Therefore, uniform plasma processing is performed continuously without causing processing variations on the workpiece (S). In addition, the number of antenna portions 40 that are arranged parallel is not limited to 3, but may be 2, or 4 or more.

FIG. 29 shows an aspect in which a long sheet-like (film-like) workpiece (S) is treated in the plasma processing apparatus 105 while being conveyed by a roll-to-roll system. The workpiece (S) is sent out from a first roll (70A), and wound up by a second roll (70B). In this way, when the workpiece (S) is windable sheet (film), it is easier to conduct continuous processing by using the plasma processing apparatus 105.

FIG. 30 shows a modified example of the one shown in FIG. 29. In this plasma processing apparatus (105A), three antenna portions 40 are arranged parallel to be positioned above and below a workpiece (S) so as to sandwich it. In antenna portions (40A, 40A, 40A), which are arranged above the workpiece (S), slot holes 41 (not shown) are provided on their respective lower sides (sides facing workpiece (S)). In antenna portions (40B, 40B, 40B), which are arranged below the workpiece (S), slot holes 41 (not shown) are provided on their respective upper sides (sides facing workpiece (S)). In this way, by arranging the antenna portions 40 both above and below the workpiece (S), while the workpiece (S) is conveyed by a roll-to-roll system, plasma processing is performed simultaneously on both sides thereof. In addition, by arranging one antenna portion (40A) above the workpiece (S) and arranging one antenna portion (40A) below the workpiece (S), plasma processing is also performed simultaneously on both sides of the workpiece (S).

The rest of the structure and its effect according to the present embodiment are the same as those of the first to sixth embodiments.

### Simulation Test

Next, the test results confirming the effect of the present invention are described. Using a plasma processing apparatus having the same structure as that shown in FIG. 1, a block 111 made of a dielectric was inserted into a waveguide of the rectangular waveguide tube 22, and the influence of the inserted block 111 on a phase of a standing wave generated in the rectangular waveguide tube 22 was simulated.

### Conditions of Simulation

As shown in FIGS. 31A and 31B, the entire length of the rectangular waveguide tube 22 was (Ly), the width was (Lx), the height was (Lz), the distance from an initiation point of the waveguide to an insertion position of the block 111 (center of block 111) in a longitudinal direction thereof was set as (r), and the insertion depth of the block 111 was set as (d). In the block 111, as shown in FIG. 31C, the length of a side parallel to a longitudinal direction of the rectangular waveguide tube 22 was (ly), and the width (length of a side parallel to a width direction of the rectangular waveguide tube 22) was (lx). In addition, in FIGS. 31A and 31B, a progression direction of a microwave being transmitted through the rectangular waveguide tube 22 from a microwave generation device was shown with a void arrow.

Only the insertion depth (d) of the block 111 was changed by the following setting of parameters, and the shift amount [mm] of a phase was calculated.

### Set Parameters

Regarding the rectangular waveguide tube 22, Ly: 800 mm, Lx: 108 mm, Lz: 56 mm, r: 690 mm, intratubular wavelength λg: 148 mm.

Regarding the block 111, specific dielectric constant ∈ᵣ 10, ly: 36 mm, lx: 36 mm, and the insertion depth (d) of the block 111 was set to be: 0 mm (no insertion), 5 mm, 10 mm, 20 mm, 25 mm, 28 mm, 30 mm, 40 mm, 45 mm, 48 mm or 50 mm.

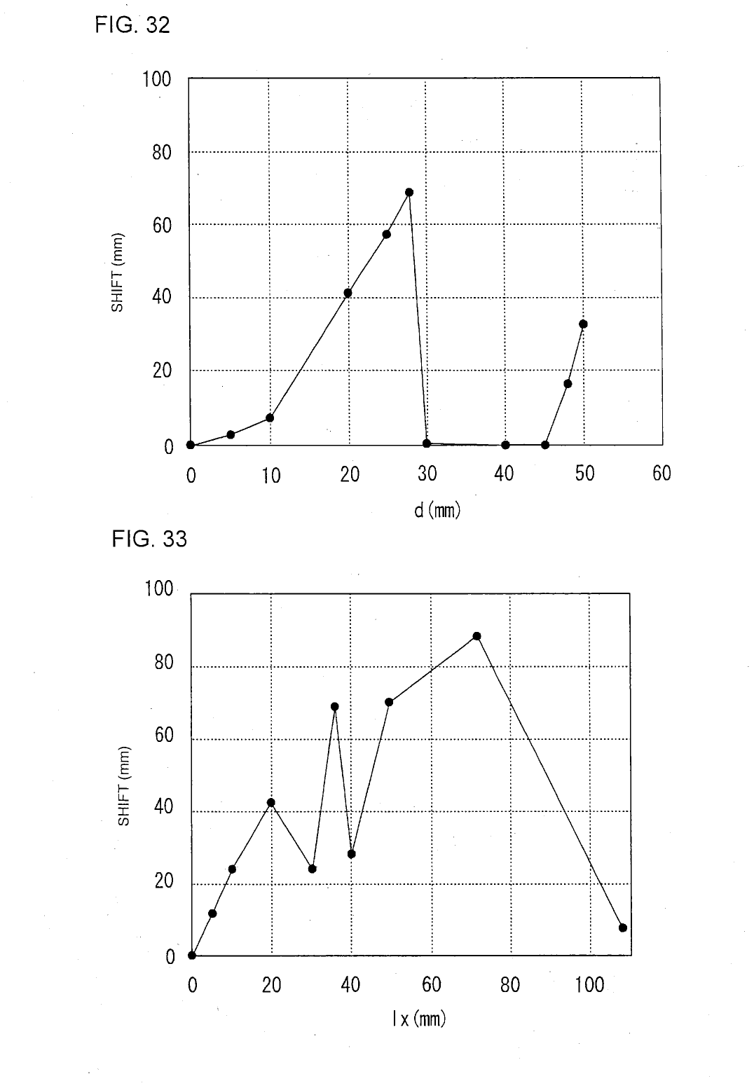

The results of the simulation are shown in FIG. 32. A Y-coordinate of FIG. 32 shows a shift (mm) of a phase, and an X-coordinate shows the insertion depth d of the block 111. Under the aforementioned simulation conditions, it is seen that in a range of the insertion depth (d) of the block 111 up to 28 mm and with a range of 45 mm or more, as (d) increases, a shift of a phase of a standing wave also increases. Therefore, it was confirmed that, by inserting the block 111 into the rectangular waveguide tube 22, a phase of a standing wave in the rectangular waveguide tube 22 is changed, thereby enabling the positions of an antinode and a node to be moved.

Next, the influence of the width of the block 111 (length of a side parallel to a width direction of the rectangular waveguide tube 22) (lx) on a shift of a phase of a standing wave was simulated. Herein, a simulation was conducted under the same conditions as those described above, except that the insertion depth (d) of the block 111 was set to be 28 mm, the distance (r) from an initiation point of a waveguide to an insertion position of the block 111 was set to be 20 mm, and the (lx) was changed as follows.

lx: 0 mm (no insertion), 5 mm, 10 mm, 20 mm, 30 mm, 36 mm, 40 mm, 50 mm, 72 mm, or 108 mm

The results of the simulation are shown in FIG. 33. A Y-coordinate of FIG. 33 shows the shift amount (mm) of a phase, and an X-coordinate shows the width (lx) of the block 111. Under the simulation conditions above, except for a range of lx=20 mm to 40 mm, and 108 mm (the same as the entire width of the rectangular waveguide tube 22), it was found that as the width (lx) of the block 111 increases, a shift of a phase tends to increase in proportion to an increase of the width (lx).

From the results of the simulation, it was confirmed that, by inserting the block 111 into the rectangular waveguide tube 22, a phase of a standing wave in the rectangular waveguide tube 22 is changed. In addition, it was also confirmed that the amount of change of a phase can be regulated by the width (lx) and the insertion depth (d) of the block 111 to be inserted into the rectangular waveguide tube 22.

So far, embodiments of the present invention have been described in detail to show the modes to carry out the present invention. However, the present invention is not limited to the embodiments above. A person skilled in the art can conduct many modifications without deviating from the concept and the scope of the present invention, and those are also included in the scope of the present invention. For example, in the above embodiments, as the workpiece (S), an FPD substrate and a film to be applied to the substrate were shown, but a processing subject was not specifically limited; for example, the present invention can be also applied to a substrate of a semiconductor wafer or the like.

The plasma generation device of one embodiment of the present invention is a plasma generation device of an atmospheric pressure system that generates uniform line plasma using a long waveguide tube and performs uniform processing on the workpiece.

By providing a means that can change a phase of a standing wave generated in a long waveguide tube, high density line plasma is generated uniformly in a longitudinal direction of the waveguide tube.

A plasma generation device according to an embodiment of the present invention includes a microwave generation device that generates a microwave; a hollow waveguide tube that is connected to the microwave generation device and is shaped long in a transmission direction of the microwave while a cross section in a direction orthogonal to the transmission direction is shaped rectangular; a gas supply device that is connected to the waveguide tube and supplies a processing gas into the interior thereof; an antenna portion that is a part of the waveguide tube and releases plasma generated by the microwave to the outside; one or multiple slot holes formed on a wall that forms a short side or a long side of the antenna portion; and a phase shifting means that cyclically shifts a phase of a standing wave by the microwave generated inside the waveguide tube. The plasma generation device plasmatizes the processing gas supplied into the waveguide tube in the atmospheric pressure state by the microwave in the slot hole, and releases the plasma to the outside from the slot hole. Also, the plasma generation device may be such that the phase shifting means has a wall member that transmits and/or reflects a microwave propagating through the waveguide tube, and cyclically changes positions of an antinode and a node of the standing wave by the wall member.

The wall member may move back and forth in a linear line, advancing into or retracting from the waveguide tube in a direction that crosses a longitudinal direction of the waveguide tube.

The wall member may perform rotational movements around an axis set in a direction corresponding to a longitudinal direction of the waveguide tube. In this case, rotational movements of the wall member may be eccentric rotations, the wall member may have a shape that is non-uniform in a rotational direction, or the wave member may have a non-uniform thickness in a longitudinal direction of the waveguide tube.

The wall member may perform rotational movements around an axis set in a direction that crosses a longitudinal direction of the waveguide tube.

The wall member may be provided at an end portion of the waveguide tube, and may move back and forth in a linear line, advancing into or retracting from the waveguide tube in a longitudinal direction of the waveguide tube.

The material of the wall member may be made of a dielectric or a metal.

The plasma generation device may further include a cover member that covers the phase shifting means.

The phase shifting means may be one pair of phase shifters that are structured to sandwich the antenna portion therebetween and are connected to the rectangular waveguide tube on both sides thereof, and the one pair of phase shifters may be actuated in a reverse phase from each other.

The slot hole may be shaped to be rectangular, and may be provided so that its longitudinal direction corresponds to a longitudinal direction of the antenna portion. In this case, only one long slot hole may be provided in the antenna portion, multiple slot holes may be disposed in one row in the antenna portion, or multiple slot holes may be arranged parallel in multiple rows in the antenna portion.

The plasma generation device may include a partition that blocks passage of the processing gas in the waveguide tube between the microwave generation device and the antenna portion.

An edge face of the slot hole may be provided obliquely so that the opening width varies in a direction of the thickness of the wall.

Furthermore, the plasma generation device may include a pulse generator, and may generate plasma by generating a pulse-type microwave.

A plasma processing apparatus according to another embodiment of the present invention includes the plasma generation device and performs predetermined processing on a workpiece using generated plasma. While cyclically shifting a phase of the standing wave by the phase shifting means, the plasma processing apparatus plasmatizes the processing gas supplied into the waveguide tube in an atmospheric pressure state by the microwave in the slot hole, and releases the plasma to the outside from the slot hole to treat a workpiece. In this case, the antenna portion may be arranged so that the slot hole faces the workpiece. Alternatively, the antenna portion may be arranged on both upper and lower surfaces of the workpiece. Moreover, the workpiece may be film-like, and may be conveyed by a roll-to-roll system.

A plasma treating method according to a further embodiment of the present invention is a method of treating a workpiece using the plasma treating device. This plasma treating method plasmatizes the processing gas supplied into the waveguide tube in an atmospheric pressure state by the microwave through the slot hole, while cyclically shifting a phase of the standing wave by the phase shifting means, and releases the plasma to the outside from the slot hole to treat the workpiece.

Since the plasma generation device and the plasma processing apparatus include a phase shifting means that cyclically shifts a phase of a standing wave generated in the waveguide tube, positions of an antinode and a node of a standing wave can be moved during a certain time period. As a result, although those devices are of an atmospheric pressure plasma system by which it is hard to generate uniform plasma, line plasma is generated to be uniform by time average in a longitudinal direction of the waveguide tube. Therefore, homogeneous processing can be performed on a large workpiece in a longitudinal direction of the waveguide tube.

Since the plasma generation device and the plasma treating device are an atmospheric pressure plasma device requiring no vacuum container, it is not necessary to provide a dielectric plate between a waveguide tube and a workpiece, and loss due to absorption of a microwave by the dielectric plate is prevented. Also, since a processing gas supplied into the waveguide tube is plasmatized with a microwave and is released to the outside from a slot hole, high-density plasma is generated effectively. In addiiton, dedicated gas introduction equipment is not required, and the size of the device can be reduced. Therefore, by performing plasma processing on a workpiece using the plasma generation device and the plasma treating device, homogeneous processing is performed with high-density plasma while energy loss is suppressed as much as possible.

Obviously, numerous modifications and variations of the present invention are possible in light of the above teachings. It is therefore to be understood that within the scope of the appended claims, the invention may be practiced otherwise than as specifically described herein.

What is claimed is:

1. A plasma generation device, comprising:
a microwave generation device configured to generate a microwave;
a waveguide tube having a hollow interior space and connected to the microwave generation device such that the waveguide tube has a longitudinal direction in a transmission direction of the microwave and a rectangular cross section in a direction orthogonal to the transmission direction;
a phase-shifting device configured to cyclically shift a phase of a standing wave generated in the interior space of the waveguide tube by the microwave; and
a gas supply device connected to the waveguide tube and configured to supply a processing gas into the interior space of the waveguide tube,
wherein the waveguide tube has an antenna portion having at least one slot hole configured to release plasma generated by the microwave to outside the waveguide tube, the slot hole is formed on a wall forming a short side or a long side of the antenna portion, and the waveguide tube is configured to plasmatize the processing gas in an atmospheric pressure state supplied into the interior space of the waveguide tube by the microwave in the slot hole and to release the plasma to outside from the slot hole.

2. The plasma generation device according to claim 1, wherein the phase shifting device has a wall member configured to at least one of transmit and reflect the microwave propagating through the interior space of the waveguide tube such that the phase shifting device cyclically changes positions of an antinode and a node of the standing wave.

3. The plasma generation device according to claim 2, wherein the phase-shifting device is configured to move the wall member back and forth in a linear line such that the wall member advances into or retracting from the interior space of the waveguide tube in a direction crossing the longitudinal direction of the waveguide tube.

4. The plasma generation device according to claim 2, wherein the phase-shifting device is configured to move the wall member in rotational motion around an axis set in a direction corresponding to the longitudinal direction of the waveguide tube.

5. The plasma generation device according to claim 4, wherein the phase-shifting device is configured to move the wall member in eccentric rotation.

6. The plasma generation device according to claim 4, wherein the wall member has a non-uniform shape in a rotational direction.

7. The plasma generation device according to claim 4, wherein the wall member has a thickness which varies in the longitudinal direction of the waveguide tube.

8. The plasma generation device according to claim 2, wherein the phase-shifting device is configured to move the wall member in rotational motion around an axis set in a direction crossing the longitudinal direction of the waveguide tube.

9. The plasma generation device according to claim 2, wherein the wall member comprises one of a dielectric material and a metal material.

10. The plasma generation device according to claim 1, further comprising a cover member which covers the phase-shifting device.

11. The plasma generation device according to claim 1, wherein the phase-shifting device is one pair of phase shifting elements positioned such that the antenna portion is interposed between the phase shifting elements and the phase shifting elements are connected to the waveguide tube on both sides of the antenna portion, respectively, and the one pair of phase shifting elements are configured to be actuated in a reverse phase mutually.

12. The plasma generation device according to claim 1, wherein the slot hole has a rectangle shape and is positioned such that the slot hole has a longitudinal direction corresponding to a longitudinal direction of the antenna portion.

13. The plasma generation device according to claim 1, wherein the waveguide tube has a partition wall positioned between the microwave generation device and the antenna portion and is configured to block passage of the processing gas between the microwave generation device and the antenna portion.

14. The plasma generation device according to claim 1, wherein the slot hole has an edge face which is formed obliquely such that the slot hole has an opening width varying in a thickness direction of the wall.

15. The plasma generation device according to claim 1, further comprising a pulse generator configured to generate the microwave in pulse to generate the plasma.

16. A plasma processing apparatus, comprising:
a support device configured to support a workpiece; and
a plasma generation device configured to generate plasma and release the plasma toward the workpiece supported by the support device,
wherein the plasma generation device has a microwave generation device configured to generate a microwave, a waveguide tube having a hollow interior space and connected to the microwave generation device such that waveguide tube has a longitudinal direction in a transmission direction of the microwave and has a rectangular cross section in a direction orthogonal to the transmission direction, a phase-shifting device configured to cyclically shift a phase of a standing wave generated in the interior space of the waveguide tube by the microwave, and a gas supply device connected to the waveguide tube and configured to supply a processing gas into the interior space of the waveguide tube, the waveguide tube has an antenna portion having at least one slot hole configured to release plasma generated by the microwave to outside the waveguide tube, the slot hole is formed on a wall forming a short side or a long side of the antenna portion, and the waveguide tube is configured to plasmatize the processing gas in an atmospheric pressure state supplied into the interior space of the waveguide tube by the microwave in the slot hole and to release the plasma to outside from the slot hole such that the plasma applies processing on the workpiece.

17. The plasma processing apparatus according to claim 16, wherein the antenna portion is positioned such that the slot hole faces the workpiece.

18. The plasma processing apparatus according to claim 17, wherein the antenna portion is formed in a plurality, and the plurality of antenna portions is positioned on each of upper and lower surfaces of the workpiece, respectively.

19. The plasma processing apparatus according to claim 17, further comprising a conveyance device configured to convey the workpiece by a roll-to-roll system, and the workpiece has a film shape.

20. A method of plasma processing, comprising:
generating plasma using a plasma generation device; and
releasing the plasma generated by the plasma generation device from the plasma generation device such that the plasma applies processing on a workpiece,
wherein the plasma generation device has a microwave generation device configured to generate a microwave, a waveguide tube having a hollow interior space and connected to the microwave generation device such that waveguide tube has a longitudinal direction in a transmission direction of the microwave and has a rectangular cross section in a direction orthogonal to the transmission direction, a phase-shifting device configured to cyclically shift a phase of a standing wave generated in the interior space of the waveguide tube by the microwave, and a gas supply device connected to the waveguide tube and configured to supply a processing gas into the interior space of the waveguide tube, the waveguide tube has an antenna portion having at least one slot hole configured to release plasma generated by the microwave to outside the waveguide tube, the slot hole is formed on a wall forming a short side or a long side of the antenna portion, and the waveguide tube is configured to plasmatize the processing gas in an atmospheric pressure state supplied into the interior space of the waveguide tube by the microwave in the slot hole and to release the plasma to outside from the slot hole such that the plasma applies processing on the workpiece.
